(19) United States
(12) Patent Application Publication
(10) Pub. No.: US 2026/0233808 A1
(43) Pub. Date: Aug. 13, 2026

(54) Hydrofoil Retraction System

(71) Applicant: REGENT Craft Inc., North Kingstown, RI (US)

(72) Inventors: Michael Christopher Tilley, Amherst, NH (US); David Michael Fornaro, North Kingstown, RI (US); Colin Alexander Docker, North Kingstown, RI (US); John Ramhorst Paris, North Kingstown, RI (US)

(73) Assignee: REGENT Craft Inc., North Kingstown, RI (US)

(21) Appl. No.: 19/657,329

(22) Filed: Apr. 24, 2026

Related U.S. Application Data
(63) Continuation of application No. PCT/US2024/048937, filed on Sep. 27, 2024.
(60) Provisional application No. 63/547,191, filed on Nov. 3, 2023.

(51) Int. Cl. B63B 1/30; B63B 1/28; B64C 35/00

(52) U.S. Cl. CPC B63B 1/30; B63B 1/285; B64C 35/006

(57) ABSTRACT

In crafts that have a hydrofoil, a locking mechanism can be used to lock the hydrofoil in place (e.g., in a retracted position or in a deployed position). However, the forces experienced by the hydrofoil, especially when in the deployed position, can cause strain on the locking mechanism, which can lead to jamming or failure. The embodiments presented herein provide a locking mechanism that can be used to avoid this problem. In one embodiment, the locking mechanism uses a pin that is movable along a single axis for engaging/disengaging a portion in a catch that is shaped to receive the pin. In another embodiment, a rear strut of the craft is rotatable, allowing the rear strut to both support the rear hydrofoil and act as a rudder of the craft when in water.

### CROSS-REFERENCE TO RELATED APPLICATIONS

This application is a continuation of PCT Application No. PCT/US2024/048937, filed September 27, 2024, which claims priority to U.S. provisional patent application no. 63/547,191, filed November 3, 2023, both of which are hereby incorporated by reference.

### BACKGROUND

Some crafts (e.g., seagliders) can operate both in water and in the air. In operation, the hull of the craft is in the water as the craft moves around a harbor and begins taxiing. As the craft gains speed, the craft’s hydrofoils cause the hull to rise above the surface of the water. As the craft gains even more speed, lift is generated by aerodynamic surfaces of the craft to cause the craft to become airborne. For landing, the craft gradually descends until the hull is back in the water.

### BRIEF DESCRIPTION OF THE DRAWINGS

FIG. 1 is a perspective view of an example craft of an embodiment.

FIG. 2A is an illustration of a craft of an embodiment in a hull-borne mode of operation.

FIG. 2B is an illustration of a craft of an embodiment in a hydrofoil-borne maneuvering mode of operation.

FIG. 2C is an illustration of a craft of an embodiment in a hydrofoil-borne takeoff mode of operation.

FIG. 2D is an illustration of a craft of an embodiment in a wing-borne mode of operation.

FIGS. 3A-3B are illustrations of an example main hydrofoil deployment system of a craft of an embodiment.

FIGS. 4A-4B are illustrations of an example rear hydrofoil deployment system of a craft of an embodiment.

FIG. 5 is an illustration of an example hydrofoil drive system of an embodiment.

FIG. 6 is an illustration of an example locking mechanism of an embodiment.

FIGS. 7A, 7B, and 7C are illustrations of a worm drive of an example locking mechanism of an embodiment.

FIGS. 8A-8D are illustrations of an example interlock of an embodiment.

FIG. 9 is an illustration of an example catch of an embodiment.

FIG. 10 is an illustration of an example hydrofoil of an embodiment in retracted and deployed positions.

FIGS. 11A-11D are illustrations of an example interlock interacting with an example catch of an embodiment.

FIG. 12 is an example of an interlock of an embodiment.

FIG. 13 is a diagram illustrating Hertzian contact stress encountered when an example interlock interacts with an example catch of an embodiment.

FIG. 14 is an illustration of an example strut of an embodiment with bearing blocks.

FIGS. 15-17 are illustrations of example components of a rear hydrofoil of an embodiment.

FIGS. 18-19 are illustrations of an example twin-screw of an embodiment.

FIG. 20 is an example control system of an embodiment.

FIG. 21 is a flow chart of an example method of an embodiment.

FIG. 22 is an illustration of an interlock of an example embodiment.

FIG. 23 is an illustration of an interlock of an example embodiment.

FIG. 24 is a cross-sectional diagram of an interlock of an example embodiment.

FIG. 25 is a cross-sectional diagram of an interlock of an example embodiment.

FIG. 26 is a perspective view of a portion of a locking system of an example embodiment.

FIG. 27 is a perspective view of a portion of a locking system of an example embodiment wherein a catch and a cover of a pin are removed to expose inside mechanics of the pin.

FIG. 28 is a cross-sectional diagram of an interlock of an example embodiment.

FIG. 29 is an illustration of an interlock of an example embodiment.

FIG. 30 is a cross-sectional diagram of an interlock of an example embodiment.

FIG. 31 is a graph depicting a main foil pin moment of an example embodiment.

FIG. 32 is a side view of a hydrofoil of an example embodiment.

FIG. 33 is a perspective view of a hydrofoil of an example embodiment.

FIG. 34 is a graph depicting a main foil pin moment of an example embodiment.

FIG. 35 is an illustration of a hydrofoil system of an example embodiment.

FIGS. 36A-36D are various structural views of a hydrofoil system of an example embodiment.

FIG. 37 is a top view of a hydrofoil of an example embodiment.

FIG. 38 is a side view of a strut of an example embodiment.

FIGS. 39A and 39B and front and side views, respectively, of a hydrofoil system of an example embodiment.

FIG. 40 is an illustration of an actuation system of an example embodiment.

FIG. 41 is an illustration of rails and a latch of an example embodiment.

FIG. 42 is an illustration of a bearing design of an example embodiment.

FIG. 43 is an illustration of an actuation system of an example embodiment.

FIG. 44 is an illustration of an actuation system of an example embodiment.

### DETAILED DESCRIPTION

### I. Introduction

In crafts that have a hydrofoil, a locking mechanism can be used to lock the hydrofoil in place (e.g., in a retracted position or in a deployed position). However, the forces experienced by the hydrofoil, especially when in the deployed position, can cause strain on the locking mechanism, which can lead to degraded performance including jamming and/or failure. For example, while foiling (i.e., with the foil deployed), the foil can encounter significant forces due to moving through the water. Also, when landing in some situations, the foil can be deployed or in a retracted position but still exposed externally. When the craft impacts the water, this exposure can result in an impact force (“dynamic loading”) that the design must account for.

Examples described herein provide a locking mechanism for an adjustable (e.g., retractable) hydrofoil that can be used to avoid these and other problems. In one embodiment, a craft is provided comprising: a hydrofoil comprising a strut; a first drive system coupled with the strut and configured to move the strut between a plurality of deployment positions; and a hydrofoil locking system. The hydrofoil interlocking system comprises a second drive system, an interlock, and a catch, which is fixed with respect to the strut and comprise a concave portion.

The interlock comprises: a first arm comprising a first end rotatably coupled with the second drive system and a second arm comprising a first end rotatably coupled with the strut. The first and second arms further comprise respective second ends that are rotatably coupled together and form a convex coupling portion.

The second drive system is configured to selectively move the first end of the first arm between first and second positions, which causes the convex coupling portion of the interlock to move respectively in and out of engagement with the concave portion of the catch to selectively lock and unlock the strut in place when the strut is in one of the plurality of deployment positions. Other embodiments are disclosed, and the disclosed embodiments can be used alone or in combination.

These and other aspects are discussed in more detail in the passages that follow and can provide several advantages. For example, the interlock is less (or not at all) prone to mechanical jamming and developing issues from wear and tear over time. Also, in examples where the second arm is longer than the first arm, the arrangement and lengths of the arms allow the upward/downward forces (forces from different directions) to react along the different respective directions/load paths. Either way, the axial force is directed into the structure of the vehicle, which amounts to a very robust load path either up or down, and no amount of force on the system has to be held by the motor/actuator of the system.

In some situations, it may be desirable for the interlock to primarily react upward/downward forces primarily in a single direction (such as downward/upward, respectively) and to minimize the extent to which those forces are reacted along different respective directions/load paths. In such situations, instead of using the two-arm design described above, the interlock can use a pin that is movable along a single axis in engaging/disengaging a portion in the catch that is shaped to receive the pin. In this way, the pin, with its single-axis geometry, functions similar to a dead-bolt lock in some aspects, such as that it slides into a “catch position” and then out.

Relatedly, however, in such a situation where the interlock is movable along a single axis, it is possible that the foil strut might be permitted to move (in the direction of the single axis) within the casing that houses the strut. For instance, as the craft accelerates during takeoff, and as the sum of moment forces due to lift and drag correspondingly change, the strut might be forcefully “racked” between the front and rear of the casing. Undesirably, such “racking” can be disruptive/uncomfortable and cause damage to the foil strut.

To mitigate and/or remove such “racking,” a structural solution can be used to help manage forces on the foil strut while foiling; namely, changing the geometry of the foil. In particular, a position of the foil relative to the strut may be moved backward so that the lift vector associated with the foil is off-center with respect to the vertical axis of the strut, such that the strut is generally pushed against one side of the casing when the craft if moving at any speed. Thereby, racking of the foil strut may be mitigated and/or avoided in normal operation of the craft.

Also, in another embodiment, the rear strut of the craft is rotatable, allowing the rear strut to both support the rear hydrofoil and act as a rudder of the craft when in water. In an example, such a combined strut and rudder may have a relatively-high span-to-chord ratio in order to enable desirable structural strength of the overall system, while at the same time enabling relatively low drag performance capability while the craft is foiling. Correspondingly, the combined strut and rudder may be housed and controlled by a novel actuation system that is capable of multiple functions including, as examples, (1) deploy/retract the strut, (2) control rotation (yaw) of the rudder, and (3) control surfaces (such as elevators and/or flaps) on the foil itself. The actuation system may be implemented so as to perform well despite unique operational challenges of the craft including those associated with landing.

### II. Example Craft

The following embodiments can be used with any suitable type of craft. Examples of suitable crafts are described in U.S. Patent Application Nos. 17/885,523; 63/459,197; and 63/493,575 and in PCT/US23/29996, each of which is hereby incorporated by reference.

The following paragraphs provide a brief summary of one example craft. The craft in this example takes the form of a wing-in-ground effect vehicle (WIG). A WIG is an aircraft vehicle capable of moving over a surface (e.g., earth or water) by gaining support from the reactions of the air against one or more surfaces of the vehicle. When such a vehicle hovers relatively close to the surface, the drag experienced by the vehicle is reduced. For example, the drag on a WIG is reduced when its distance from the ground is within about half the length of the vehicle’s wingspan.

It should be understood that the following summary is merely an example, and that other crafts can be used. So, the various details provided herein and in the patent documents that are incorporated by reference should not be read into the claims unless expressly recited therein. It should also be understood that other crafts and features not described in those documents can be used. For example, while the example craft described in the ‘523 patent application uses a particular hydrofoil retraction system to move a hydrofoil and lock the hydrofoil in place, other mechanisms can be used to move the hydrofoil and/or lock it in place. Examples of other such mechanisms are provided after the following description of the example craft from the ‘523 patent application. These movement mechanisms and locking mechanisms can be used alone or in combination with each other and can be used with the example craft described below or with other crafts.

### A. Overview of Example Craft

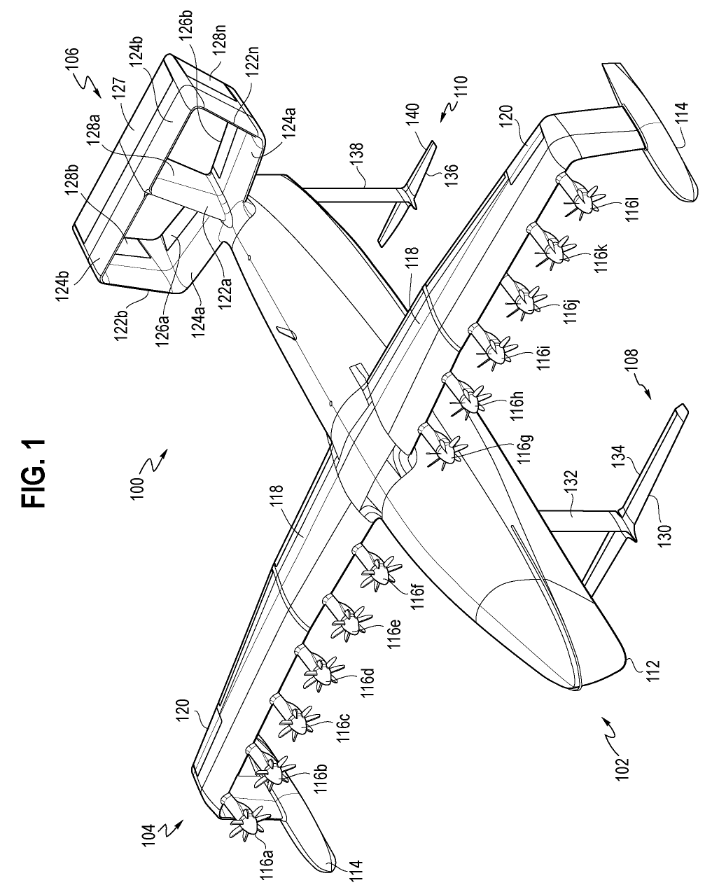

Turning now to the drawings, FIG. 1 is a perspective view of an example craft 100 of an embodiment. As shown, some examples of the craft 100 include a hull 102, a main wing 104, a tail 106, a main hydrofoil assembly 108, and a rear hydrofoil assembly 110.

Some examples of the craft 100 operate in a first waterborne mode for an extended period of time, during which the hull 102 is at least partially submerged in water. As such, some examples of the hull 102 are configured to be watertight, particularly for surfaces of the hull that contact the water during this first waterborne operational mode. Further, some examples of the hull 102, as well as the entirety of the craft 100, are configured to be passively stable on all axes when floating in water. To help achieve this, some examples of the hull 102 include a keel (or centerline) 112, which provides improved stability and other benefits described below. Some examples of the craft 100 include various mechanisms for adjusting the center of mass of the craft 100 so that the center of mass aligns with the center of buoyancy of the craft 100. For instance, in some examples, a battery system (described in further detail below) of the craft 100 is electrically coupled to one or more moveable mounts. Some examples of the mounts are moved by one or more servo motors or the like. In some examples, a control system of the craft 100 is configured to detect a change in its center of buoyancy, for instance, by detecting a rotational change via an onboard gyroscope, and responsively operate the servo motors to move the battery system until the gyroscope indicates that the craft 100 has stabilized. Some examples of the craft 100 include a ballast system for pumping water or air to various tanks distributed throughout the hull 102 of the craft 100. The ballast system facilitates adjusting the center of mass of the craft 100 so that the center of mass aligns with the center of buoyancy of the craft 100. Other example systems may be used to control the center of mass of the craft 100 as well.

Additionally, or alternatively, some examples of the hull 102 are configured to reduce drag forces when both waterborne and wing-borne. For instance, some examples of the hull 102 have a high length-to-beam ratio (e.g., greater than or equal to 8), which facilitates reducing hydrodynamic drag forces when the craft 100 is under forward waterborne motion. Some examples of the keel 112 are curved or rockered to improve maneuverability when waterborne. Further, some examples of the hull 102 are configured to pierce the surface of waves (e.g., to increase passenger and crew comfort) by including a narrow, low-buoyancy bow portion of the hull 102.

Some examples of the main wing 104 include an outrigger 114 at each end of the main wing 104. The outriggers 114 (which are sometimes referred to as “wing-tip pontoons”) are configured to provide a buoyant force to the main wing 104 when submerged or when otherwise in contact with the water, which improves the stability of the craft 100 during waterborne operation.

Some examples of the main wing 104 have a gull-wing shape such that the outriggers 114 at the ends of the main wing 104 are at the lowest point of the main wing 104 and are positioned approximately level with (or slightly above) a waterline of the hull 102 when the hull 102 is waterborne.

Some examples of the main wing 104 have a high aspect ratio, which is defined as the ratio of the span of the main wing 104 to the mean chord of the main wing 104. In some examples, the aspect ratio of the main wing 104 is greater than or equal to five, or greater than or equal to six, but other example aspect ratios are possible as well. Such wings tend to have reduced pitch stability and maneuverability due to lower roll angular acceleration. These issues are ameliorated by various mechanisms described below. On the other hand, such wings tend to have increased roll stability and increased efficiency resulting from higher lift-to-drag ratios. Further, high aspect ratio wings provide a longer leading edge for the mounting of a distributed propulsion system along the wing.

Some examples of the main wing 104 include a number of electric motor propeller assemblies 116 distributed across a leading edge of the main wing 104. This arrangement corresponds to a blown-wing propulsion system. Arranging the propeller assemblies 116 in this manner increases the speed of air moving over the main wing 104, which increases the lift generated by the main wing 104. This increase in lift allows the craft 100 to take off and become wing-borne at slower vehicle speeds. This facilitates, for example, taking off on water which can be difficult at higher speeds due to the various forces that would otherwise act on the craft 100.

The electric motor propeller assemblies 116 tend to be much lighter, less complex, and smaller than the liquid-fueled engines used on conventional craft. Some examples of the electric motor propeller assemblies 116 are controlled by an electronic speed controller and powered by an onboard battery system (e.g., a lithium-ion system, magnesium-ion system, lithium-sulfur system, etc.). Some examples of the electric motor propeller assemblies 116 are controlled by a fuel cell or a centralized liquid-fueled electricity generator. In some examples, the onboard electrical supply system includes multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during wing-borne operation, each of which are described in further detail below).

In some examples, the positioning of the electric motor propeller assemblies 116 along the leading edge of the main wing 104 is determined based on a variety of factors including, but not limited to, (i) the required total thrust for all modes of operation of the craft 100, (ii) the thrust generated by each individual propeller of the propeller assemblies 116, (iii) the radius of each propeller in the respective propeller assemblies 116, (iv) the required tip clearance between each propeller and the surface of the water, and (v) the additional freestream speed over the main wing 104 required for operation.

As shown in the figures, in some examples, the number of propeller assemblies 116 is symmetrical across both sides of the hull 102. In some examples, the propeller assemblies 116 are identical. In some examples, the propeller assemblies 116 have different propeller radii or blade configurations along the span so long as the configuration is symmetrical across the hull 102. The different radii facilitate adequate propeller tip clearance from the water or vehicle structure. In some examples, the different propellers are optimized for different operational conditions, such as wing-borne cruise. The propeller placement and configuration may vary to increase the airflow over the main wing 104 or tail system 106 to improve controllability or stability. While eight total propeller assemblies 116 are illustrated, the actual number of propeller assemblies 116 can vary based on the requirements of the craft 100.

In some examples, the propeller assemblies 116 have different pitch settings or variable pitch capabilities based on their position on the main wing 104. For instance, in some examples, a subset of the propeller assemblies 116 have fixed-pitch propellers sized for cruise speeds, while the remainder of the propeller assemblies 116 have fixed-pitch propellers configured for takeoff or can allow for varying the propeller’s pitch.

In some examples, different propeller assemblies 116 are turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the craft 100, allowing the craft 100 to turn without large bank angles and increasing the turning maneuverability of the craft 100. For instance, in order to yaw right, the craft 100 may increase the rotational speeds of the propellers of one or more of propeller assemblies 116g-l while decreasing the rotational speeds of the propellers of one or more of propeller assemblies 116a-f. Similarly, to yaw left, the craft 100 may increase the rotational speeds of the propellers of one or more of propeller assemblies 116a-f while decreasing the rotational speeds of the propellers of one or more of propeller assemblies 116g-l.

Similarly varying rotational speeds or propeller pitches may be used to yaw or roll the aircraft in flight or while foiling due to varied forces and lift distributions imposed over the wing and its control surfaces or in general used to tailor the lift distribution across the wing for optimized efficiency.

In some examples, the propeller assemblies may tilt to vector thrust either to provide directly more vertical lift or to change how the wing is blown depending on the mode of operation so as to tailor the blown lift distribution.

Some examples of the main wing 104 include one or more aerodynamic control surfaces, such as flaps 118 and ailerons 120. Some examples of these controls comprise movable hinged surfaces on the trailing or leading edges of the main wing 104 for changing the aerodynamic shape of the main wing 104. Some examples of the flaps 118 are configured to extend downward below the main wing 104 to reduce stall speed and create additional lift at low airspeeds, while some examples of the ailerons 120 are configured to extend upward above the main wing 104 to decrease lift on one side of the main wing 104 and induce a roll moment in the craft 100. In some examples, the ailerons 120 are additionally configured to extend downward below the main wing 104 in a flaperon configuration to help the flaps 118 generate additional lift on the main wing 104, which, in some examples, is used to either create a rolling moment or additional balanced lift depending on coordinated movement of both ailerons. Some examples of the flaps 118 and ailerons 120 include one or more actuators for raising and lowering the flaps 118 and ailerons 120. Within examples, the flaps 118 include one or more of plain flaps, split flaps, slotted flaps, Fowler flaps, slotted Fowler flaps, Gouge flaps, Junkers flaps, or Zap flaps. Further, in some examples, the flaps 118 (and the ailerons 120 when configured as flaperons) are positioned to be in the wake of one or more of the propeller assemblies 116. In some examples, the ailerons 120 are positioned so that they are in the wake of one or more of the propeller assemblies 116 to increase the effectiveness of the ailerons at low forward velocities. Some of the propeller assemblies 116 are positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

As illustrated in FIG. 1, an example tail 106 includes a vertical stabilizer 122, a horizontal stabilizer 124, and one or more control surfaces, such as elevators 126. Similar to the flaps 118 and ailerons 120, some examples of the elevators 126 comprise movable hinged surfaces on the trailing or leading edges of the horizontal stabilizer 124 for changing the aerodynamic shape of the horizontal stabilizer 124 to control a pitch of the craft 100. Some examples of the horizontal stabilizer 124 are combined with the elevators 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. Some examples of the elevators 126 include actuators, which are operated by a control system of the craft 100 to raise and lower the elevators 126.

Some examples of tail 106 include a rudder 128. Some examples of the rudder 128 comprise a movable hinged surface on the trailing edge of the vertical stabilizer 122 for changing the aerodynamic shape of the vertical stabilizer 122 to control the yaw of the craft 100 when operating in an airborne mode. In some examples, the rudder 128 additionally changes a hydrodynamic shape of the hull 102 to control the yaw of the craft 100 when operating in a waterborne mode. To facilitate such hydrodynamic control, in some examples, the rudder 128 is positioned low enough on the tail 106 that the rudder 128 is partially or entirely submerged when the hull 102 is floating in water. For instance, the rudder 128 is positioned partially or entirely below the waterline of the hull 102. Some examples of the rudder 128 include one or more actuators, which are operated by a control system of the craft 100 to rotate the hinged surface of the rudder 128 to the left or right of the vertical stabilizer 122. Actuating the rudder 128 to the left (relative to the direction of travel) causes the craft 100 to yaw left. Actuating the rudder 128 to the right (relative to the direction of travel) causes the craft 100 to yaw right. As such, the rudder 128 may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

Some examples of the tail 106 include one or more vertical stabilizers 122a, 122b, 122n, one or more horizontal stabilizers 124a, 124b, one or more control surfaces, such as elevators 126, and one or more tail flaps 127 for enhanced pitch control configured to exert enhanced net downward force on the tail system. It should be understood that although the figures show only two horizontal stabilizers, it is contemplated that more than two of each can be used within the scope of the present teachings. In some applications, it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the craft 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a is a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, the structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downwards lift can be generated during desired phases of operation.

Some examples of the horizontal stabilizers 124a, 124b include one or more aerodynamic control surfaces, such as tail flaps 127 and elevators 126, which may comprise movable hinged surfaces on the trailing or leading edges of the horizontal stabilizer 124a, 124b for changing the aerodynamic shape of the respective horizontal stabilizer 124a, 124b. It should be recognized that at least one of the horizontal stabilizers 124a, 124b can be sized, shaped, and/or spaced relative to a second of the horizontal

stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some non-limiting example configurations, the surface area of the first horizontal stabilizer is 5.7 m2, the surface area of the second horizontal stabilizer is 3.9 m2, both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some examples, a vertical separation distance can be dependent on the required rudder authority and thus elevator size (driven by, e.g., yaw stability, or the need to counteract asymmetric thrust following powerplant failure). In some examples, a sweep offset moves the center of pressure further aft from the center of gravity, thus allowing the airfoil of the horizontal stabilizer to have less surface area overall, thus being smaller and lighter. In some examples, a dihedral in the bottom surface of the horizontal stabilizer adds stability. In some examples, the box tail design itself increases the efficiency due to the elimination of wingtip vortices of a typical tail. In some embodiments, a lower horizontal stabilizer may have approximately a 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5 degree deflection in the left vertical control surface may move the mean pressure distribution left/right by a percentage of the elevator width.

Some examples of the tail flaps 127 are configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at which the horizontal stabilizer 124 becomes aerodynamically effective by creating additional net downward force at low airspeeds to aid in exerting a nose-up pitching moment of the craft 100. The elevators 126 may be configured for changing the aerodynamic shape of the horizontal stabilizer 124 to further control or vary a pitch of the craft 100.

In some examples operations, the tail flaps 127 are deployed for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed for other phases of operation, such as hull-borne mode, to reduce downforce on the tail system and reduce drag.

In some examples, the elevators 126 are additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 or the fuselage of the craft 100 (to provide the potential for reduced cross-sectional area and associated drag).

Further, in some examples, the elevators 126 and/or the tail flaps 127 are positioned so that they are in the wake 129 of one or more of the propeller assemblies 116 of main wing 104. The elevators 126 and/or the tail flaps 127 may be positioned so that they are in the wake 129 of one or more of the propeller assemblies 116 to increase the effectiveness of the elevators at low forward velocities. In some examples, the propeller assemblies 116 are positioned so that no elevators 126 and/or tail flaps 127 are in the wake 129 to ensure consistent and/or predictable aerodynamic forces, independent of power application, are exerted during critical operational phases. In some examples, the propeller assemblies 116 are positioned so that the elevators 126 are in their wake 129 and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the craft 100, will have the added unexpected benefit of creating additional nose-up pitching moment as a result of induced drag acting about the center of gravity causing the craft 100 to pitch upward.

Similar to the flaps 118 and the ailerons 120 of the main wing 104, some examples of the elevators 126 comprise movable hinged surfaces on the trailing or leading edges of the horizontal stabilizer 124 for changing the aerodynamic shape of the horizontal stabilizer 124 to control a pitch of the craft 100. The horizontal stabilizer 124 may be combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. The elevators 126 may include actuators, which may be operated by a control system of the craft 100 in order to raise and lower the elevators 126.

In some examples, the tail 106 includes one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the craft 100 when operating in an airborne mode. It should be understood that rudders 128a, 128b,128n can operate independently or in combination as desired. Moreover, in some examples, rudders 128a, 128b, 128n can be used as redundant systems, particularly useful in the event of one or more failures.

In some examples, the rudders 128a, 128b, 128n additionally change a hydrodynamic shape of the hull 102 to control the yaw of the craft 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the craft 100 in order to rotate the hinged surface of the rudders 128a, 128b, 128n to the left or right of the vertical stabilizer 122. Actuating the rudders 128a, 128b, 128n to the left (relative to the direction of travel) causes the craft 100 to yaw left. Actuating the rudders 128a, 128b, 128n to the right (relative to the direction of travel) causes the craft 100 to yaw right. As such, the rudders 128a, 128b, 128n may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

It should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

Some examples of the craft 100 include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the craft 100 at lower travel speeds. When determining the number and size of propeller assemblies to include on the tail 106, one may apply the same factors described above when determining the number and size of propeller assemblies to include on the main wing 104.

B. Example Modes of Operation

The craft 100 can be operated in a plurality of modes of operation, examples of which are described below.

1. Hull-Borne Operation

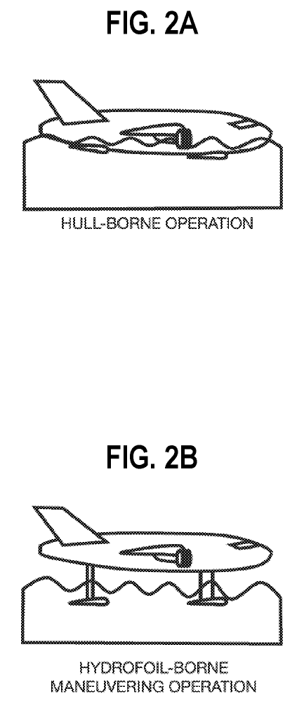

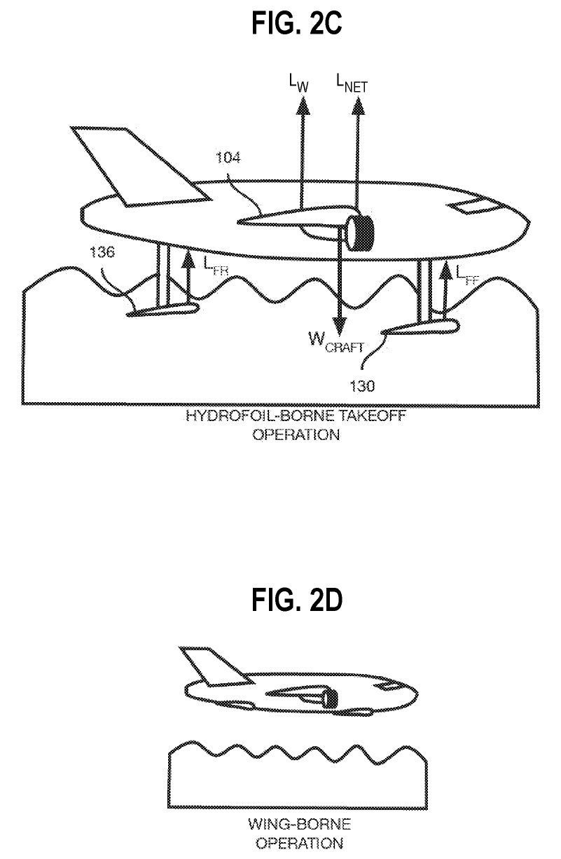

FIG. 2A illustrates an example of the craft 100 when the craft 100 is operating in a hull-borne mode. During this mode, the craft 100 is docked and floating on the hull 102, with the buoyancy of the outriggers 114 providing for roll stabilization of the craft 100. When the craft 100 is ready to depart, the craft 100 uses its propulsion systems, including the propeller assemblies 116 and/or the underwater propulsion system (e.g., one or more propellers mounted to the hull 102, the main foil 130, and/or the rear foil 136), to maneuver away from the dock while remaining hull-borne. In some examples, the main hydrofoil assembly 108 and the rear hydrofoil assembly 110 remain retracted (or partially retracted) during this maneuvering to reduce the risk of hitting underwater obstacles near docks or in shallow waterways. However, when there is a limited risk of hitting underwater obstacles, the craft 100 may partially or fully extend the main hydrofoil assembly 108 and/or the rear hydrofoil assembly 110. With the main hydrofoil assembly 108 and/or the rear hydrofoil assembly 110 extended, the craft 100 actuates the main foil control surfaces 134 and/or the rear foil control surfaces 140 to improve maneuverability as described above.

### 2. Hydrofoil-Borne Maneuvering Operation

FIG. 2B illustrates an example of the craft 100 when the craft 100 is operating in hydrofoil-borne maneuvering mode. During this mode, the craft 100 is configured to, for example, move through harbors and crowded waterways at speeds generally between 20-45 mph. In this regard, the craft 100 may extend the main hydrofoil assembly 108 and the rear hydrofoil assembly 110 (if not already extended) and accelerate using the propulsion system towards a desired takeoff speed. During acceleration, the craft 100 reaches a speed at which the main hydrofoil assembly 108 and the rear hydrofoil assembly 110 alone support the weight of the craft 100, and the hull 102 is lifted above the surface of the water (e.g., by 3-5 ft) so that the hull is clear of any surface waves. After the hull 102 leaves the surface of the water, the drag forces exerted on the craft 100 drop significantly, and the amount of thrust required to maintain acceleration can be reduced. The control system of the craft 100 can sustain this operational mode by actively controlling the pitch and speed of the craft 100, so that the main hydrofoil assembly 108 and the rear hydrofoil assembly 110 continue to entirely support the weight of the craft 100.

The height at which the hull 102 is elevated above the surface of the water during hydrofoil-borne operation is limited by the length of the one or more main foil struts 132 that couple the main foil 130 to the hull 102 and the length of the one or more rear foil struts 138 that couple the rear foil 136 to the hull 102. In some examples, the main foil struts 132 and the rear foil struts 138 are long enough to lift the hull 102 at least five feet above the surface of the water during hydrofoil-borne operation, which facilitates operation in water with larger wave heights (e.g., wave heights up to five feet). However, struts of other lengths can be used as well. For instance, some examples may utilize longer struts that allow for better wave-isolation of the hull 102 (but at the expense of the stability of the craft 100 and the increased complexity of the retraction system).

3. Hydrofoil-Borne Takeoff Operation

FIG. 2C illustrates an example of the craft 100 when the craft 100 is operating in hydrofoil-borne takeoff mode. During this mode, the craft 100 is configured to, for example, move through open waters and obtain speeds generally between 40-50 mph to facilitate generating the lift required to become wing-borne. As the craft 100 moves through water with the main foil 130 and the rear foil 136 submerged, the foils generate a lifting force that causes the hull 102 to rise above the surface of the water. In general, the lifting force generated by the foils must be at least equal to the weight of the craft 100 to cause the hull 102 to rise above the surface of the water. The lifting force of the foils depends on the speed and angle of attack at which the foils move through the water, as well as their various physical dimensions, including the aspect ratio, the surface area, the span, and the chord of the foils.

In general, as shown in FIG. 2C, to sustain takeoff and accomplish flight, the aero lift L_{W} generated by the wings and the aero lift L_{FR}, L_{FF} generated by the main and rear foils 130, 136 (the sum of which is represented in FIG. 2C as L_{NET}) should exceed the weight, W_{CRAFT}, of the craft. Once a sufficient lift is achieved, the craft 100 becomes wing borne, as shown in FIG. 2D. In some examples, once the transition from hydrofoil-borne operation to wing-borne operation is complete, the control system of the craft causes the main hydrofoil assembly 108 and the rear hydrofoil assembly 110 to retract. In some examples, the control system initiates this retraction as soon as the hydrofoil assemblies 108, 110 are clear of the water to reduce the chance of the hydrofoil assemblies 108, 110 reentering the water.

4. Return to Hull-Borne Operation

To facilitate transitioning from wing-borne to hull-borne mode of operation (from FIG. 2D to FIG. 2A), the control system of the craft 100 can determine that the hydrofoil assemblies 108, 110 are fully retracted so that the craft 100 may safely land on its hull 102. However, in other examples, the hydrofoil assemblies 108, 110 are at least partially deployed when the craft 100 lands, so the hydrofoil assemblies 108, 110 impact the water during landing.

In some examples, after the craft 100 is settled in the water, the craft 100 is transitioned back to hydrofoil-borne maneuvering mode (see FIG. 2B) by extending the hydrofoil assemblies 108, 110 to transition from hull-borne operation to hydrofoil-borne operation in the same manner as described above. In some examples, the control system of the craft 100 then sustains the hydrofoil-borne mode and maneuvers the craft 100 into port while keeping the hull 102 insulated from surface waves. The control system of the craft 100 can then reduce the thrust generated by the propeller assemblies 116 to lower the speed of the craft 100 until the hull 102 settles into the water, thereby transitioning that craft back to hull-borne operation. The control system of the craft 100 can then retract the hydrofoil assemblies 108, 110 and perform the hull-borne operations described above to maneuver the craft 100 into a dock for disembarking passengers or goods and recharging the battery system 200.

It should be noted that U.S. Patent Application No. 17/885,523, which is hereby incorporated by reference, describes that foil retraction may be used when the foil is in different positions through landing procedure. It should also be noted that PCT/US23/29996, which is hereby incorporated by reference, describes that a locking mechanism might be used while the foil is deployed during takeoff, then the foil is moved to the retracted position and is locked in the retracted position while flying.

C. Example Hydrofoil Deployment Systems

As noted above, the craft 100 can dynamically control an extent to which the main foil 130 and/or the rear foil 136 are deployed based on an operational mode (e.g., hull-borne, hydrofoil-borne, or wing-borne modes) of the craft 100. For instance, during hull-borne mode, the rear hydrofoil assembly 110 may be partially deployed or retracted to increase turning authority. The amount of partial deployment or retraction may be a function of the desired overall vehicle draft when operating in a shallow water environment. During hydrofoil-borne mode, the main hydrofoil assembly 108 may be partially retracted to reduce the distance between the hull of the vehicle and the water’s surface. This may increase the amount of lift generated by the main wing 104 by operating the wing closer to the surface of the water, increasing the effects of the aerodynamic ground effect.

As also noted above, one or both of the main hydrofoil assembly 108 or the rear hydrofoil assembly 110 may interface with a deployment system that facilitates retracting the main hydrofoil assembly 108 and/or the rear hydrofoil assembly 110 into or toward the hull 102 for hull-borne or wing-borne operation and extending the main hydrofoil assembly 108 and/or the rear hydrofoil assembly 110 below the hull 102 for hydrofoil-borne operation. As described further below, in some examples, the deployment system may be used in connection with extending, retracting, and/or otherwise controlling the positioning of the main hydrofoil assembly 108 and/or the rear hydrofoil assembly 110 during takeoff when the craft 100 is transitioning from hydrofoil-borne operation to wing-borne operation.

One feature of this example hydrofoil deployment system is that the main hydrofoil assembly 108 and/or the tail hydrofoil assembly 110 is capable of retracting from a fully-deployed state once the craft 100 is entirely in wing-borne operation. Conventional deployment systems are insufficient for use with the craft 100 for a number of reasons including, but not limited to, being incapable of deploying hydrofoil assemblies during water-borne or wing-borne operation, being incapable of deploying hydrofoil assemblies large enough for use with the craft 100, being manually operated, and being too fragile to withstand a sufficient number of deployment cycles that would be carried out over the lifetime of the craft 100. Example hydrofoil deployment systems that include features to help address these issues are described below.

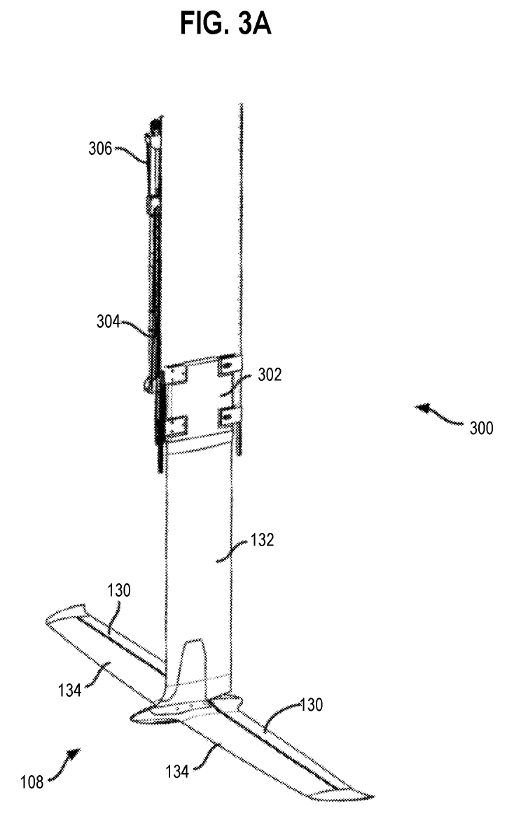

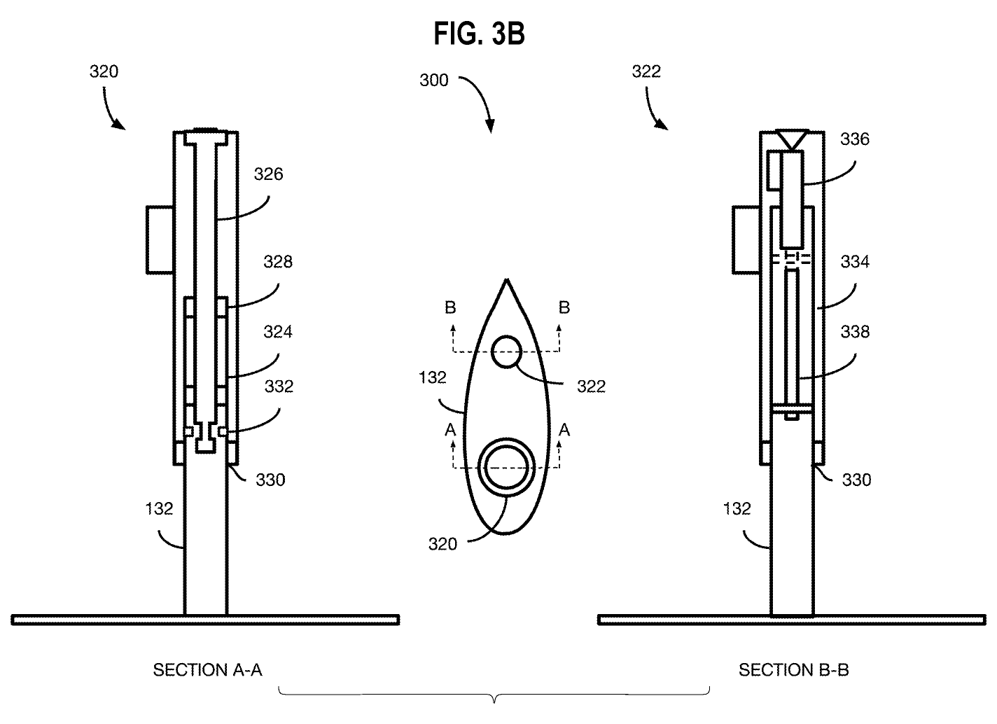

FIG. 3A depicts an example of a main hydrofoil deployment system 300 that facilitates retracting and extending the main hydrofoil assembly 108. As shown, some examples of the main hydrofoil deployment system 300 take the form of a linear actuator that includes one or more brackets 302 that couple the main hydrofoil assembly 108 (by way of the main hydrofoil strut 132) to one or more vertical tracks 304. Some examples of the brackets 302 are configured to move vertically along the tracks 304, such that when the brackets 302 move vertically along the tracks 204, the main hydrofoil assembly 108 likewise moves vertically. Some examples of the brackets 302 are coupled to a leadscrew 306 that, when rotated, causes vertical movement of the brackets 302. Some examples of the leadscrew 306 are rotatable by any of various sources of torque, such as an electric motor coupled to the leadscrew 306 by a gear assembly 308.

Some examples of the main hydrofoil deployment system 300 further include one or more sensors 310 configured to detect a vertical position of the main hydrofoil assembly 108. For example, a first sensor senses when the main hydrofoil assembly 108 has reached a fully retracted position and a second sensor senses when the main hydrofoil assembly 108 has reached a fully extended position. However, the main hydrofoil deployment system 300 may include additional sensors for detecting additional discrete positions or continuous positions of the main hydrofoil assembly 108. Some examples of the sensors are included as part of, or otherwise configured to communicate with, the control system of the craft 100 to provide the control system with data that indicates the position of the main hydrofoil assembly 108. Some examples of the control system use this data to determine whether to operate the electric motor to retract or extend the main hydrofoil assembly 108.

In some examples, such as examples where the linear actuator is not a self-locking linear actuator, the main hydrofoil deployment system 300 includes a locking or braking mechanism for holding the main hydrofoil strut 132 in a fixed position (e.g., in a fully retracted or fully extended position). An example of the locking mechanism corresponded to a dual-action mechanical brake that is coupled to the electric motor, the leadscrew 306, or the gear assembly.

While the above description provides various details of an example main hydrofoil deployment system 300, it should be understood that the main hydrofoil deployment system 300 illustrated in FIG. 3A is for illustrative purposes and is not meant to be limiting. For instance, the main hydrofoil deployment system 300 may include any of various linear actuators now known or later developed that are capable of retracting and extending the main hydrofoil assembly 108.

FIG. 3B depicts another example of the main hydrofoil deployment system 300 that facilitates retracting and extending the main hydrofoil assembly 108 using a linear actuator comprising a dual-channel configuration. As shown by the top-down cross-sectional view of one of the main foil struts 132 in FIG. 3B, each main foil strut 132 may include a first linear channel 320 and a second linear channel 322. FIG. 3B further depicts a more detailed view of the first linear channel 320 in the cross-sectional view of section A-A, as well as a more detailed view of the second linear channel 322 in the cross-sectional view of section B-B.

The first linear channel 320 may be configured to guide the linear actuation of the main hydrofoil assembly 108 and provide reinforcing structural support to the main hydrofoil assembly 108, while the second linear channel 322 may be configured to apply an actuation force to the main hydrofoil assembly 108. In this regard, the main hydrofoil deployment system 300 may include a first column 324 having a linear guide 326 arranged in an interior portion of the first column 324. The main foil strut 132 may be configured to slide vertically in the interior portion of the first column 324 and along the linear guide 326.

In order to reduce friction while maintaining a snug fit, the first linear channel 320 may include one or more bearing elements 328 configured to interface between the first linear channel 320 and the linear guide 326. Further, the first column 324 may include one or more gaskets 330 at the interface of the main foil strut 132 and the first column 324 to facilitate sealing the interior portion of the first column 324 from water or other contamination.

The first linear channel 320 may further include a locking mechanism 332. The locking mechanism 332 may be configured to lock the main foil strut 132 in a given deployment position (e.g., in a fully-deployed position, a fully-retracted position, or some intermediate position) by interlocking with a corresponding receptacle in the linear guide 326. The locking mechanism 332 may be a passive locking mechanism or an active locking mechanism, which may be controlled by a control system of the craft 100.

The second linear channel 322 may include a second column 334 having a linear actuator 336 arranged in an interior portion of the second column 334. The second linear channel 322 may further include a coupling mechanism 336 configured to couple the actuator 336 to the main foil strut 132, which may be configured to slide vertically in the interior portion of the second column 334. The actuator 336 may be configured to apply an upward or downward force to the main foil strut 132 by way of the coupling mechanism 336, thereby causing the main foil strut 132 to move vertically within the first and second linear channels 320, 322. In operation, the control system control system of the craft may cause the linear actuator 336 to apply an upward force to the main foil strut 132 to retract the main hydrofoil assembly 108, and the control system control system of the craft may cause the linear actuator 336 to apply a downward force to the main foil strut 132 to deploy the main hydrofoil assembly 108. Using such a dual-channel configuration may improve the structural integrity of the main hydrofoil deployment system 300 by reducing some of the stress forces applied to the actuator 336 during operation and offloading those forces onto the linear guide 326.

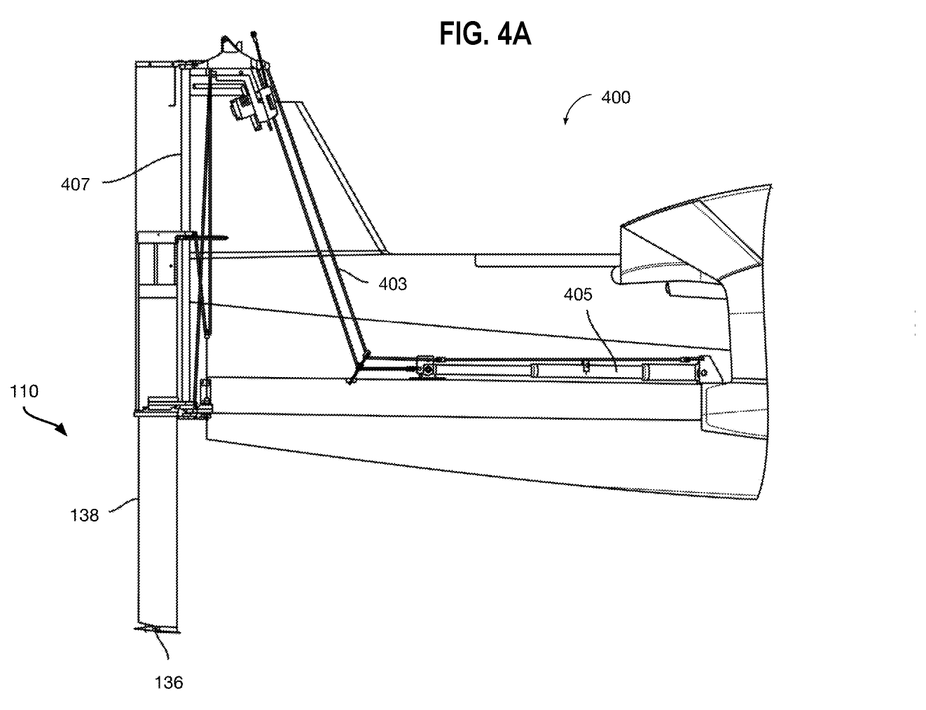

FIGS. 4A and 4B depict an example of a rear hydrofoil deployment system 400 that facilitates retracting and extending the rear foil 136. As shown, the rear hydrofoil deployment system 400 may include a pulley system 403 that couples an actuator 405 to the rear foil strut 138. When actuated, the actuator 405 causes the pulley system 403 to raise or lower the rear foil strut 138 by causing the rear foil strut 138 to slide vertically along a shaft 407. While not depicted in FIGS. 4A and 4B, in some examples, the rudder 128 may also be mounted to the shaft 407 such that, when the actuator 405 raises the rear foil strut 138, the rear foil strut 138 retracts at least partially into the rudder 128. Additionally, some examples of the rear hydrofoil deployment system 400 may include one or more servo motors configured to rotate the rear foil strut 138 around the shaft. In this respect, the rear foil strut 138 may be rotated around the shaft to act as a hydro-rudder when submerged in water or to act as an aero-rudder when out of the water. Further, because the rudder 128 is mounted to the same shaft 407 as the rear foil strut 138 and the rear foil strut 138 can be retracted into the rudder 128, the same servo motor can also be used to control the rotation of the rudder 128.

The actuator 405 of the rear hydrofoil deployment system 400 may take various forms and may, for instance, include any of various linear actuators now known or later developed that are capable of retracting and extending the rear hydrofoil assembly 110. Further, in some examples, the actuator 405 may have a non-unitary actuation ratio such that a given movement of the actuator 405 causes a larger corresponding induced movement of the rear hydrofoil assembly 110. This can help allow for faster retractions of the rear hydrofoil assembly 110, which may be beneficial during takeoff, as described in further detail below.

Some examples of the main hydrofoil assembly 108 and/or the rear hydrofoil assembly 110 may be configured such that, when fully retracted, the hydrofoil assembly is flush, conformal, or tangent to the hull 102 and/or tail 106. For instance, in some examples, the hull 102 and/or tail 106 may include one or more recesses configured to receive the main hydrofoil assembly 108 and/or the rear hydrofoil assembly 110, and the main hydrofoil assembly 108 and/or the rear hydrofoil assembly 110 may be shaped such that when the main hydrofoil assembly 108 and/or the rear hydrofoil assembly 110 are fully retracted into the one or more recesses of the hull 102 and/or tail 106, the outer contour of the hull 102 and/or tail 106 forms a substantially smooth transition at the intersection of the hull 102 and the main hydrofoil assembly 108 and/or the tail 106 and the rear hydrofoil assembly 110.

In other examples, the main hydrofoil assembly 108 and/or the rear hydrofoil assembly 110 may not conform to the shape of the hull 102 and/or tail 106 when fully retracted but instead may protrude slightly below the hull 102 and/or tail 106. In these examples, the main hydrofoil assembly 108 and/or the rear hydrofoil assembly 110 may have a non-negligible effect on the aerodynamics of the craft 100, and the craft 100 may be configured to leverage these effects to provide additional control of the craft 100. For instance, when the main hydrofoil assembly 108 and/or the rear hydrofoil assembly 110 are retracted but still exposed, the exposed hydrofoil may be manipulated in flight to impart forces and moments on the craft 100 similar to an aero-control surface.

Some examples of the main hydrofoil assembly 108 and/or the rear hydrofoil assembly 110 may further include various failsafe mechanisms in case of malfunction. For instance, if one or both of the main hydrofoil deployment system 300 or the rear hydrofoil deployment system 400 cannot be retracted due to a malfunction, then the craft 100 may be configured to jettison the malfunctioning assembly. In this regard, the main hydrofoil assembly 108 and/or the rear hydrofoil assembly 110 may be coupled to the hull 102 by a releasable latch. The control system of the craft 100 may be configured to identify a retraction malfunction (e.g., based on data received from the positional sensors 310) and responsively open the latch to release the connection between the hull 102 and the malfunctioning hydrofoil assembly. In some examples, the weight of the malfunctioning hydrofoil assembly may provide sufficient force to jettison the malfunctioning hydrofoil assembly out of the hull 102 when the latch is opened. However, some examples of the craft 100 may include an actuator or some other mechanism to jettison the malfunctioning hydrofoil assembly out of the hull 102. In some examples, the main hydrofoil assembly 108 and/or the rear hydrofoil assembly 110 may be configured to break in a controlled manner upon impact with a water surface. For instance, a joint between the main foil struts 132 and the hull 102 and/or a joint between the rear foil struts 138 and the hull 102 may be configured to disconnect when subjected to a torque significantly larger than standard operational torques at the joints. Other designs for providing controlled breaks are possible as well.

III. Example Hydrofoil Retraction System

A. Introduction

In various examples of the craft described above, the craft is described as including a particular hydrofoil retraction system to move the hydrofoil between deployed and retracted positions and lock the hydrofoil into place.

In one such example, the hydrofoil was retracted and extended using a linear actuator that includes one or more brackets that couple the main hydrofoil assembly (by way of the main foil struts) to one or more vertical tracks. The brackets may be configured to move vertically along the tracks, so as to move the hydrofoil assembly. As noted, the linear-actuator may be self-locking to hold the foil struts in various fixed positions, and/or the deployment system may include one or more additional locking mechanisms for holding the foil struts in various fixed positions.

In another such example, the hydrofoil had two linear channels. The first linear channel guided the linear actuation of the hydrofoil and provided reinforcing structural support, while the second linear channel applied an actuation force to move a strut of the hydrofoil between deployed and retracted positions. The actuation force was applied using a linear actuator with one or more brackets coupling the strut and a leadscrew. Rotation of the leadscrew (e.g., by an electric motor) caused vertical movement of the brackets to move the strut/hydrofoil between deployed and retracted positions. The first linear channel included a passive or active locking mechanism controlled by a control system of the craft. The locking mechanism locked the strut in place in a given deployment position (e.g., in a fully-deployed position, a fully-retracted position, or some intermediate position) by interlocking with a corresponding receptacle in a linear guide.

As mentioned above, other mechanisms can be used to move the hydrofoil and/or lock it in place. The following paragraphs describe examples of other such mechanisms. It is important to note that the movement mechanisms and the locking mechanisms described below can be used alone or in combination with each other. For example, the movement and locking mechanisms described below can be used together, the movement mechanisms can be used with other locking mechanism (including, but not limited to, the locking mechanisms described above), and the locking mechanisms can be used with other movement mechanism (including, but not limited to, the movement mechanisms described above (e.g., those using a dual channel configuration). Also, these mechanisms can be used with any suitable craft, including, but not limited to, the craft discussed above).

B. Example Hydrofoil Drive System

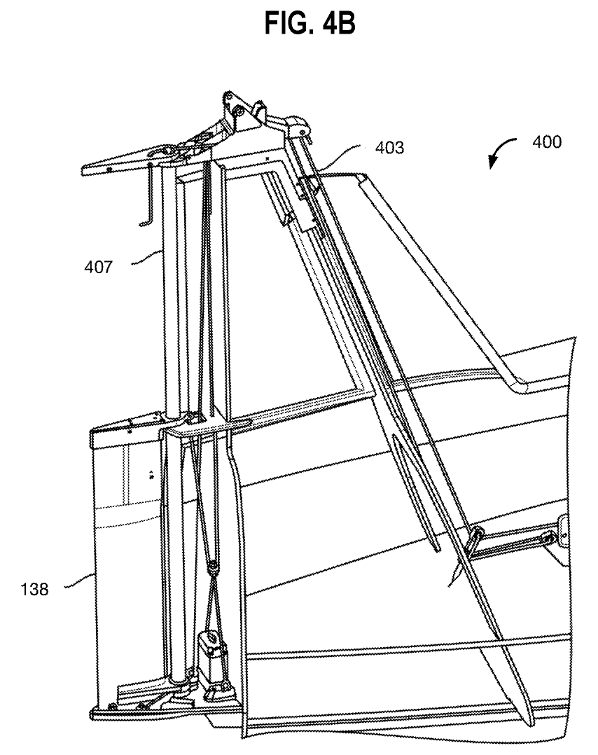

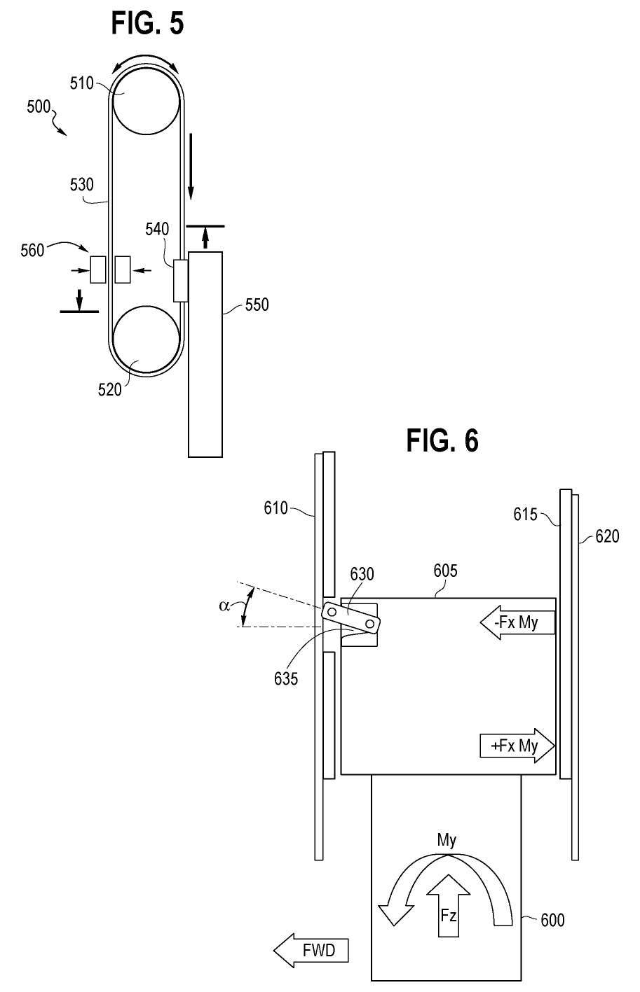

In one embodiment, the craft uses a linear drive system to move the strut (and, hence, the hydrofoil) between a plurality of deployment positions (i.e., to apply force to deploy and retract the hydrofoil). While the drive system can use hydraulics or ropes, in one example embodiment, the drive system comprises a belt drive (e.g., a synchronous power transmission belt or a toothed power/timing belt) directly attached to the foil within a single channel (or casing) that at least partially surrounds the strut. This example embodiment will now be described in conjunction with FIG. 5.

As shown in FIG. 5, the drive system of this embodiment comprises a belt drive 500 having a top pulley 510 and a bottom pulley 520. An electrically-driven servomotor (not shown) drives the top pulley 520 to rotate a belt 530 wrapped around the top and bottom pulleys 510, 520. A belt clamp 540 secures the belt 530 to a strut 550 of a hydrofoil. As indicated by the arrows in FIG. 5, movement of the belt 530 in a counterclockwise fashion around the top and bottom pulleys 510, 520 causes the strut 550 to move up (in a retraction direction). Similarly, movement of the belt 530 in a clockwise fashion around the top and bottom pulleys 510, 520 would cause the strut 550 to move down (in a deployed direction). In this way, a control system of the craft can control the servomotor to position the strut 550 in any desired position (e.g., in a fully-deployed position, in a fully-retracted position, or in some intermediate position).

Once the strut 550 is moved to the desired position, any suitable mechanism, and/or a combination of multiple mechanisms, can be used to hold the strut 550 in place. For example, as shown in FIG. 5, a clamp 560 can be used to engage with and clamp the belt 530, so the belt 530 can no longer translate, thereby holding the strut 550 in place. However, other locking mechanisms can be used instead or additionally, such as, but not limited to, the locking mechanisms discussed below. Other alternatives can be used as well. For example, the foil control system can involve separate channel(s) within the foil itself that is used to communicate physical control (e.g., via control rods) from input/actuators at the top of the foil structure down to the actual elements on the foils themselves. So, the foil can contain one or more such channels for translating control actions and signaling to elements on the foil (e.g., control surfaces, locking mechanisms, etc.) using mechanism push rods.

The drive system of this embodiment provides several advantages. For example, it may be desired for the speed at which the hydrofoil is retracted (the “retraction speed”) to be relatively fast even over significant distance and with significant weight. That is, a drive system may be required to retract the hydrofoil relatively quickly to satisfy safety and performance requirements (e.g., for takeoff, landing, and emergency situations). Using the belt drive 500 in this embodiment can satisfy such requirements. In one particular example, the belt drive 500 can be configured to retract a hydrofoil weighing ~260 kg over a distance of two meters in about 10 seconds. As another advantage, using an electrically-driven servomotor for the retraction drive (as opposed to a manual or hydraulic retraction mechanism) allows for precision control over the placement of the belt with respect to components in the craft that are used to lock the strut in place.

C. Example Locking Mechanisms

As discussed above, many different types of mechanisms can be used to lock a strut of a hydrofoil in place. The selection of a particular type of locking mechanism can depend on several challenges and constraints. So, the design of the locking mechanism can present a multitude of competing design considerations, which can result in a relatively-constrained set of requirements that need to be optimized around. One such requirement can be performance while foiling (e.g., force management while loaded and foiling). While foiling (i.e., with the foil deployed), the foil can encounter significant forces due to moving through the water. The foil, in a “fixed” position, needs to be capable of receiving this load without failing and must be “stiff”/stable enough to provide control stability for the craft. This can include generally “redirecting” loads/forces into the vehicle structure to minimize their impact and a design/architecture that does not (or is not susceptible to) jam.

Another requirement can be performance while landing (i.e., impact force at landing even while retracted). In some situations, the foil can be deployed, and hence exposed, during landing. In some situations, even if landing while the foil is in a retracted position, the foil can still be exposed at least partially externally. When the craft impacts the water, this exposure can result in an impact force (“dynamic loading”) that the design must account for. Other requirements can include, but are not limited to, robustness to environment/ getting wet (especially in a salty environment), a need to maximize reliability overall including the ability to perform throughout thousands of cycles, and the need to minimize overall weight of the retraction system (to promote performance of craft generally).

In the following example, some relevant requirements include the need to avoid jamming under high loading conditions (drag) and the need to be able to handle primary and significant (big) loads. One load is an axial (upwards) load which is referred to herein as “Fz,” and the other load is a drag load (reaction from the moment of drag) which is referred to herein as “My.” The axial load can be the easier load to deal with, as it is parallel to major structural components of the craft. In contrast, the drag load can be more significant and challenging to deal with. This is especially true when the hydrofoil itself is relatively long (e.g., two-to-three meters), as the hydrofoil acts as a torque wrench when foiling, which can result in a large amount of force (e.g., over 10,000 pounds of drag force).

1. Shackle Pin

Several possible locking mechanisms can be used to meet the relevant requirement(s), and FIG. 6 is an illustration of one such locking mechanism. FIG. 6 shows the strut (sometimes referred to herein as the “post”) 600 of the hydrofoil between two walls 610, 620 of the channels (or casing) that at least partially surrounds the strut 600. As shown in FIG. 6, there is some small amount of space between the strut 600 of this embodiment and the walls of the channel, which creates a “running clearance” for the strut 600 to move. Other embodiments might not be as constrained from a weight standpoint, so they can be designed with “higher precision” (i.e., with less of a gap/space between components). However, with the gap/space in this embodiment, a mechanism is used to help reflect/deal with loads at issue here when a force causes the strut 600 to act against the walls 610, 620 of the channels.

More specifically, when the system is loaded (foiling), the strut 600 will rotate until it makes contact with the walls 610, 620 of the channels. At that point, the strut 600 will be situated at an indeterminate angle that a locking mechanism should account for. In fact, the angle will even change over time with general wear and tear. To deal with this, the locking mechanism in this embodiment generally functions so as to “shove” the strut 600 towards/into one of the channel walls (in this example, wall 620). Making planar contact with the wall 620 helps avoid the strut 600 from “twisting” along the direction of travel of the craft and gives control over the angle by attempting to control for the gap.

In this particular example, such control is provided for the interaction of a shackle pin 630 (coupled to one of the walls 610) and a shackle pin catch 635 in the head 605 of the strut 600. This locking mechanism is designed around a ratio of Fx to My. More specifically, at a prescriptive engagement angle of the shackle pin 630, the force input on the strut 600 equals the foiling load (Fx), and the force output equals the countering load (-Z) and lateral load (+X). The lateral reaction force drives the strut head 605 against an aft glide block 615 of the wall 620 opposite the shackle pin 630. This eliminates the clearance, develops a preload, and prevents racking, which maintains nominal foil angle of incidence.

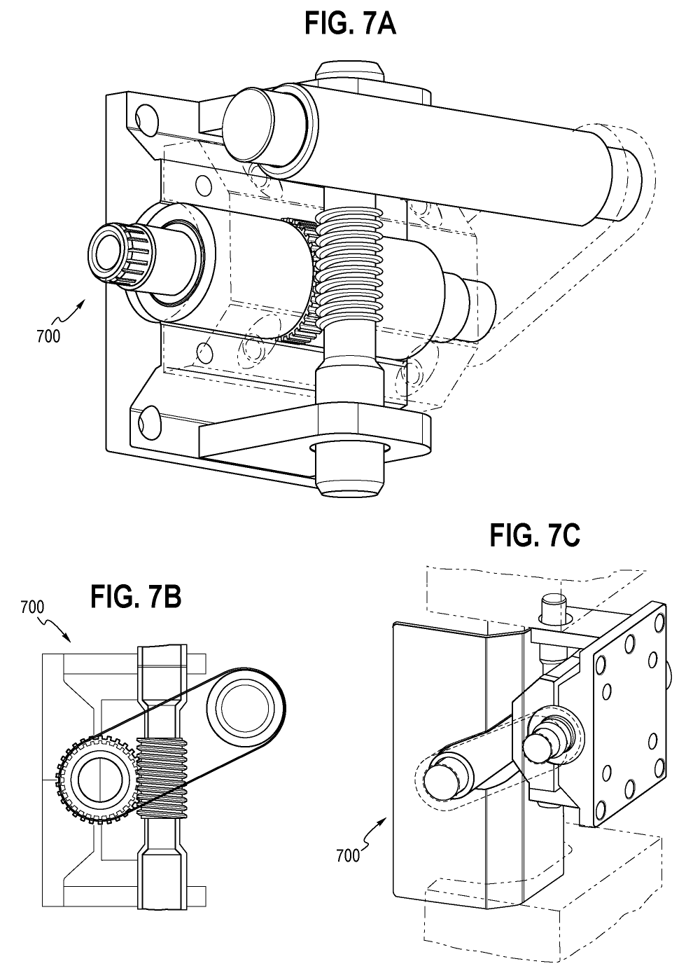

The shackle pin 630 can be operated in any suitable way. For example, as shown in FIG. 7A-7C, a worm drive 700 can be used to deploy the shackle pin 630. As the screw turns, it causes the shackle pin 630 to rotate, increasing the size/distance of the shackle pin 630 in the horizontal direction and pushing the strut head 605 into the casing wall 620. It should be noted that, in this embodiment, the shackle pin 630 is attached/deployed from the casing (into the strut). It should also be noted that the views in FIGS. 7A and 7B are in an opposite direction than in FIG. 7C (e.g., in FIG. 7C the casing attached to the shackle pin is on the right).

2. Interlock Mechanism

In the above embodiment, to lock the strut of the foil in place, a shackle pin in the case wall engaged an opening in the strut as it passed by the shackle pin. In the following embodiment, the strut contains an interlock mechanism (which is sometimes referred to herein simply as an “interlock”) that engages with a catch in the case wall or some other structure fixed with respect to the moving strut. This arrangement provides several advantages, which will be discussed below.

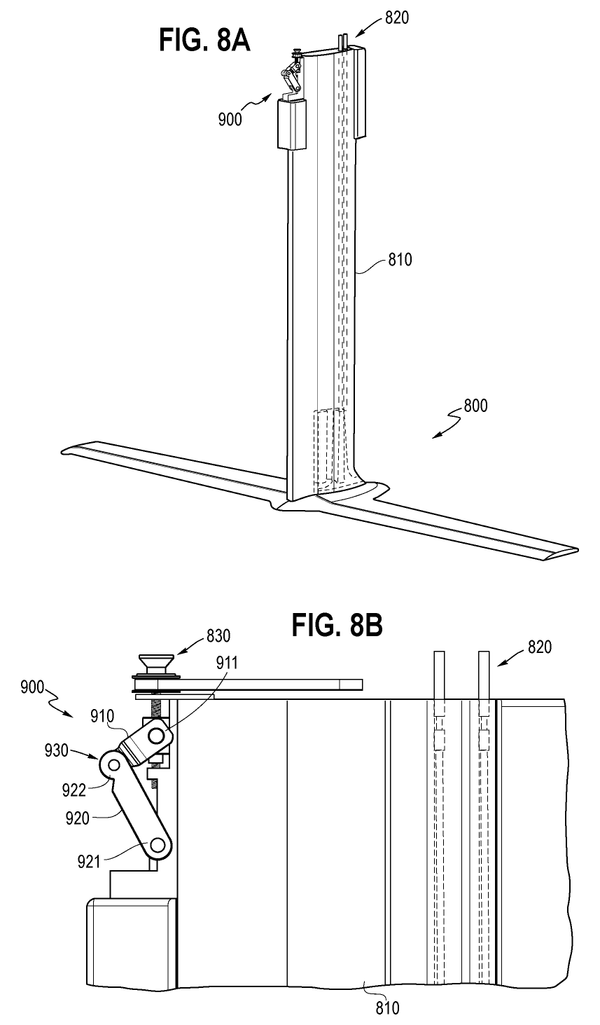

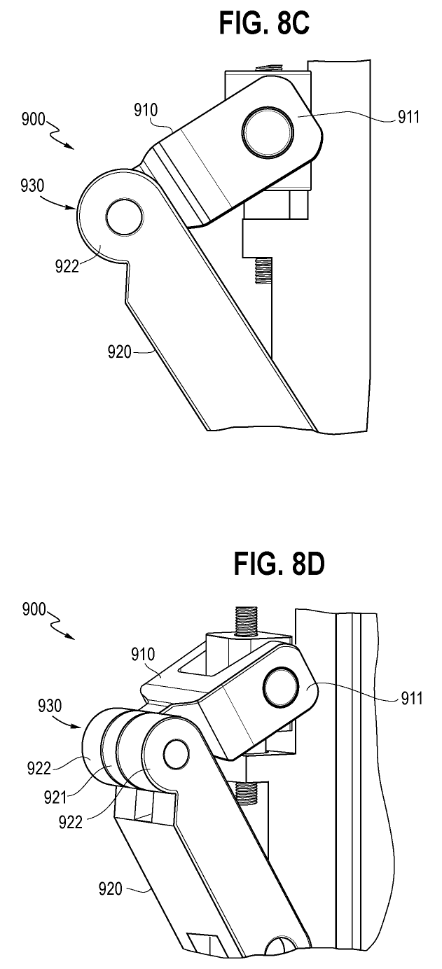

Turning again to the drawings, FIG. 8A is a perspective view of a hydrofoil 800 having a strut 810 with an interlock 900 of this example. (As used herein, “coupled with” can mean directly coupled with or indirectly coupled with through one or more intermediate components, which may or may not be shown and described herein.) The hydrofoil 800 in this example is the front (main) hydrofoil of the craft, and a configuration of the rear hydrofoil of the craft is discussed below. However, it is important to note that these embodiments can be applied to any suitable hydrofoil. As such, the details provided below with reference to the front hydrofoil and the rear hydrofoil should not be read into the claims unless expressly recited therein.

FIG. 8A also shows a first drive system (e.g., a belt drive system, as discussed above) 820 configured to move the strut 810 between a plurality of deployment positions (e.g., a fully-deployed position, a fully-retracted position, and/or one or more intermediate positions). While a belt drive system 820 is shown in this example, it should be noted that other drive systems can be used.

FIG. 8B is a close-up side view of the interlock 900, and FIGS. 8C and 8D are even-closer side and perspective views, respectively, of the interlock 900. As shown in these drawings, the interlock 900 in this embodiment comprises a first arm 910 with a first end 911 rotatably coupled with a second drive system (e.g., a linear screw, which is sometimes referred to herein as a power screw) 830. The interlock 900 also comprises a second arm 920 with a first end 921 rotatably coupled with the strut 810. In an example, the second arm 920 is longer than the first arm 910. The first and second arms 910, 920 further comprise respective second ends 921, 922 that are rotatably coupled together and form a convex coupling portion 930. As used herein, a “convex coupling portion” refers to the area where the first and second ends 912, 922 of the first and second arms 910, 920 are rotatably coupled together. The portion of that area 930 that is pointing away from the strut 810 has a convex shape. In this particular example, the second ends 912, 922 of the first and second arms 910, 920 are both rounded and have the same diameter, and the second end 912 of the first arm 910 is sandwiched between two portions of the second end 922 of the second arm 920. (In an alternate embodiment, the opposite arrangement is used, where the second end 922 of the second arm 920 is sandwiched between two portions of the second end 912 of the first arm 910.) So, when the first and second ends 912, 922 are rotatably coupled together with a fastener (e.g., a bolt), the resulting convex coupling portion 930 is also rounded and forms a convex shape.

Other configurations are possible while still resulting in a convex coupling portion 930. For example, instead of the second ends 912, 922 of the first and second arms 910, 920 having the same diameter, the second end 912 of the first arm 910 can have a smaller diameter or even a non-rounded shape smaller than the diameter of the second end 922 of the second arm 920 (because the second end 912 of the first arm 910 is sandwiched between two portions of the second end 922 of the second arm 920). In that alternative, the convex coupling portion 930 would be formed just from the second end 922 of the second arm 920, as the first end 912 of the first arm 911 would not be exposed.

As mentioned above, the first end 911 of the first arm 910 is rotatably coupled with the second drive system 830 (here. the linear screw). When the linear screw rotates, the first end 911 of the first arm 910 moves on an axis substantially parallel to a longitudinal axis of the strut 810. So, the first end 911 of the first arm 910 moves either upwards or downward on that axis depending on the rotation of the linear screw. Because the second end 912 of the second arm 920 is rotatably coupled with but otherwise fixed to the strut 810, the longitudinal movement causes the second end 912 of the second arm 920 to rotate. Because of the linkage between the first and second arms 910, 920, the longitudinal movement of the first end 911 of the first arm 910 causes the convex coupling portion 930 to move generally laterally (perpendicular to the longitudinal axis of the strut 810), with some longitudinal movement. So, the convex coupling portion 930 moves generally laterally away from and closer to the strut 810 with the movement of the first end 911 of the first arm 910.

This movement can allow the interlock 900 to lock the strut 810 in place. For example, the craft can comprise a catch 840 (see FIG. 9) (and/or multiple such catches) that is fixed respect to the strut 810 (e.g., physically stationary and rigidly attached to the wall or other structure in the craft) and that has a concave portion 850 sized to engage with the convex coupling portion 930 to lock the strut in 810 in place in one of a plurality of deployment positions.

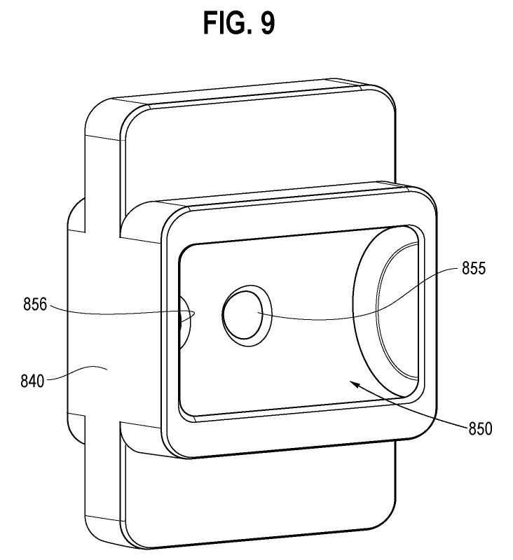

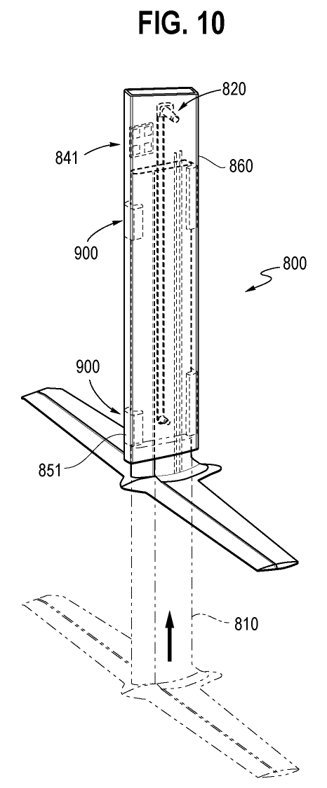

This is further illustrated in FIG. 10. In the example shown in FIG. 10, the craft has two catches 841, 851 in the casing 860 that at least partially surround the strut 100. (In other crafts, the catches 841, 851 can be located in a different structure, such as, for example, the dual-channel configuration discussed above or the rack discussed below.) The first catch 841 is located toward the top of the casing 860 and is in a position to lock the strut 810 in place when the hydrofoil 800 is in a fully-retracted position. The second catch 851 is located toward the bottom of the casing 860 and is in a position to lock the strut 810 in place when the hydrofoil 800 is in a fully-deployed position. While two catches 841, 851 are shown in this example, one or more additional catches can be used to lock the strut 810 in place when the hydrofoil 800 is in one or more positions between the fully-deployed and fully-retracted positions. In other embodiments, only a single catch is used. In still other embodiments, a relatively large number of catches may be used, such as 10 or more catches. Also, the catch can be the sole locking mechanism for the hydrofoil 800 or can be used in conjunction with other locking mechanisms. Further, the interlock 900 can be responsible for rigidly/securely holding the hydrofoil 800 in place (at various places) throughout the deployment of the hydrofoil 800 by selectively engaging with the catches 841, 851.

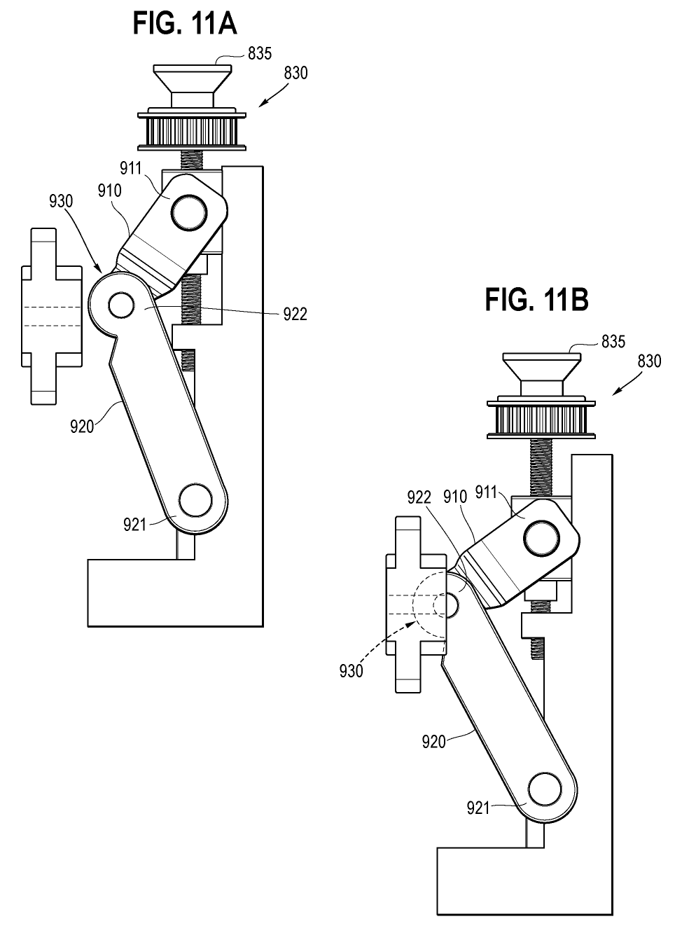

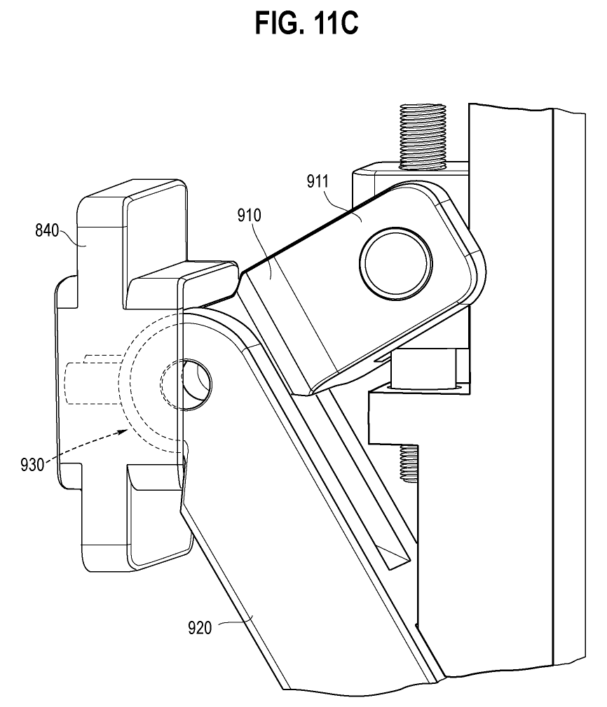

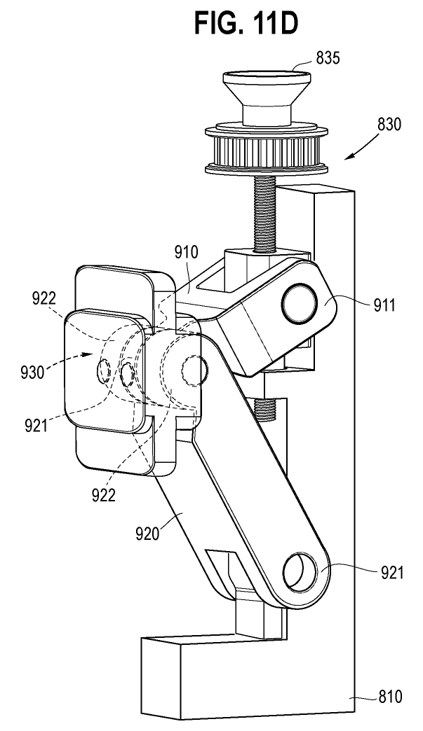

FIGS. 11A and 11B illustrate this locking/unlocking operation in more detail. In FIGS. 11A and 11B, the first drive system 820 moves the strut 810 in a position where the convex coupling portion 930 of the interlock 900 is generally adjacent to the recess of the catch 840. With the first end 911 of the first arm 910 being at a first (top) position (FIG. 11A), the convex coupling portion 930 of the interlock 900 is spaced laterally away from the recess of the catch 840. However, when the second drive system 830 moves the first end 911 of the first arm 910 downward to a second (bottom) position (FIG. 11B), the downward movement of the first end 911 of the first arm 910 causes the convex coupling portion 930 of the interlock 900 to move laterally closer to and eventually in engagement with the recess of the catch 840. This locks the strut 810 in place in one of the plurality of deployment positions. When the convex coupling portion 930 is inserted into the recess 850 of the catch 840, there can be a slight arc (vertical movement) of the convex coupling portion 930 that inserts into the catch 840. So, during deployment, the hydrofoil 800 can be moved slightly upward (e.g., two millimeters or less).

FIGS. 11C and 11D are perspective views that show the strut 810 locked in place. As shown in these drawings, a completely-rigid coupling is provided without appreciable “give”, bump stops, and shock attenuation, as the components are completely locked in with all forces being transferred into the structure of the craft that is coupled with the catch 840.

Referring back to FIG. 9, in one embodiment, the catch 840 comprises one or more sensors 855, 856 (see FIG. 9) that are configured to sense when the concave portion 850 of the catch 840 receives the convex coupling portion 930 of the interlock 900. In this way, the sensors 855, 856 (e.g., an “out-of-loop” sensor light) can sense/know when the locking mechanism is deployed and, thereby, act as an external supervisor/check of whether lock was accomplished. Additionally or alternatively, the sensors 855, 856 can be used to sense when the convex coupling portion 930 of the interlock 900 is adjacent to the concave portion 850 of the catch 840 for controlling lock deployment. However, if both the first and second drive systems 820, 830 are equipped with internal position sensors, that may be sufficient to manage deployment accurately.

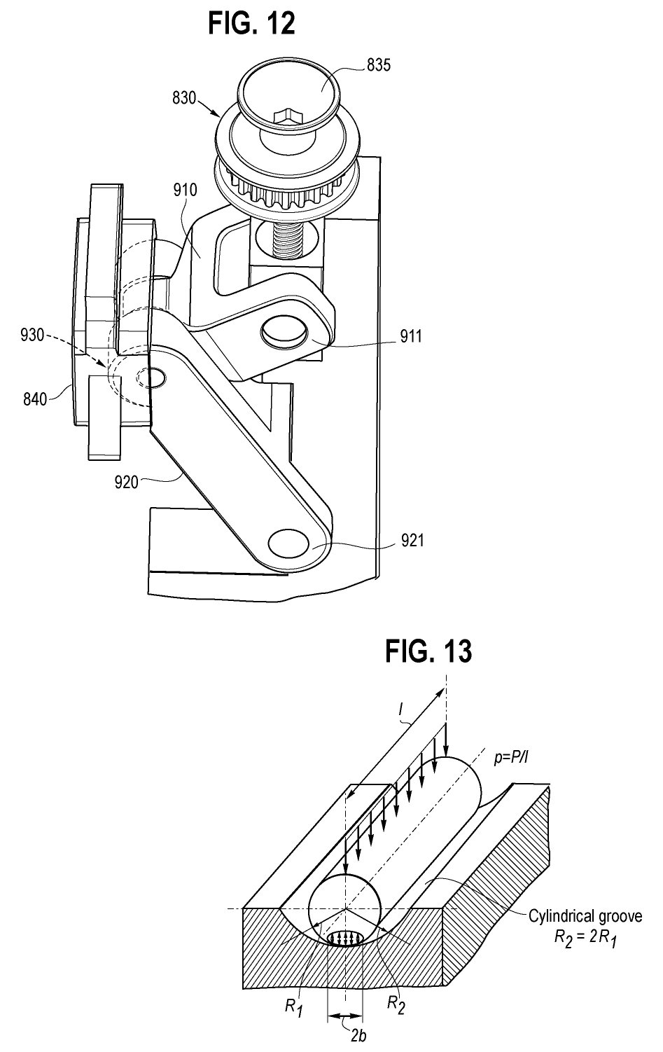

To unlock the strut 810, the second drive system 830 moves the first end 911 of the first arm 910 upward (FIG. 11A), which causes the convex coupling portion 930 of the interlock 900 to move laterally away from and out of engagement with the recess of the catch 840, thereby unlocking the strut 810. In the event that the second drive system 830 becomes inoperable, the second drive system 830 can comprise a manual override 835 (e.g., accessible through an emergency hatch in the body of the craft, such as in the cockpit), which allows an occupant of the craft to place a tool (e.g., a hex tool) in the manual override 835 to turn the linear screw to manually to engage or disengage the interlock 900. FIG. 12 shows a perspective view of the manual override 835.

In summary, in this embodiment, the second drive system 830 is configured to selectively lock and unlock the strut 810 in place by selectively moving the first end 911 of the first arm 910 between first and second positions due to multiple elements of the interlock that react with respect to each other. In this example, the second drive system 830, the interlock 900, and the catch 840 make up the hydrofoil locking system of this example. Further, the first drive system 820, in combination the hydrofoil locking system make up the hydrofoil retraction system of the craft.

There are several advantages associated with this embodiment. For example, as discussed above, the convex coupling portion 930 has a spherical (convex), half-cylinder surface that interfaces with a corresponding spherical (concave), half-cylinder surface of the catch 840. As such, there is less of a chance for mechanical jamming and wear-and-tear issues over time.

Also, in examples where the second arm is longer than the first arm, the arrangement and lengths of the arms allow the upward/downward forces (forces from different directions) to react along the different respective directions/load paths. This amounts to a very robust load path either up or down, and no amount of force on the system has to be held by the motor/actuator of the system. That is, with this embodiment, there is minimal wear on the linear screw itself, as the linear screw is not susceptible to dynamic loading. Instead all of the loading is dealt with via the angled short and long arms 910, 920. This results in a completely self-locking and completely passively-held system.

Turning again to the drawings, FIG. 13 provides an illustration that highlights some considerations relevant to arriving at specific aspects of an implementation, such as specific dimensions, of the convex coupling portion 930 and the recess 850 of the catch 840. More specifically, Hertzian contact stress can be a consideration in determining the dimensions and whether there is a strong junction between the convex coupling portion 930 and the recess 850. Hertzian contact stress refers to the localized stresses that develop as two curved surfaces come in contact and deform slightly under the imposed loads. Evaluation of Hertzian contact stress formulas informs what the contact area 830 of the interlock 900 and the catch 840 will be assuming expected loads and other design inputs and, thus, what the resultant stress will be. These formulas can take into consideration, for example, the expected system loads coming from the hydrofoil 800 (e.g., during taking off, landing, while foiling, etc.), various material properties generally describing how the materials interface (e.g., Young’s modulus, Poisson's ratio, yield stress, etc.), the sizing of the convex coupling portion 930 and the recess 850, friction between the materials, and angle of deployment when interlock 900 is fully deployed.

Regarding friction between the materials, Mu_s (the static coefficient of friction) can be an important variable. The static coefficient of friction is a measure of the amount of friction existing between two surfaces at rest. This variable can be based on assumptions/a look-up table and can be validated/observed in a lab. This characteristic tends to be repeatable but can change under different conditions/designs (e.g., placing the interlock 900 in salt water can change the actual Mu_s). So, the system can be designed to account for such changing conditions in use and over time.

Regarding angle of deployment when the interlock 900 is fully deployed, the analysis can account for wear on the elements and how the angle might vary over time of service life; essentially “worst-case-scenario” assumptions. A reasonable angle of engagement can be determined significantly as a function of static coefficient of friction and may not necessarily depend in relatively significant part on force or the size of the system, as it is just a function of the materials used.

In one particular implementation, the two diameters of the catch 840 and the interlock 900 can be sized so that (1) stress is reduced (so, the diameters should not be too different) and (2) the components do not jam. Also, the gap can be sized as large as possible to avoid jamming issues, but while avoiding “blowing out” the contact pressures. The analysis provides an assumed “contact stress” under the various design inputs/assumptions provided (and then iteration on the inputs can be used to reach a given design).

The catch 840 can be made of any suitable material and, in one example, is a corrosion resistant material, such as nickel, aluminum or bronze, which can take very-high surface pressures without wear. In one example implementation (other implementations are possible, the diameter of catch is 41 mm; the diameter of interlock is 40 mm; high strength stainless steel, 17-4 PH are used for the upper link, lower link, and the frame; 630 bronze is used for the catch and slider block; the upper link has a 85.4 mm link length, and a 40mm height; the lower link has a 125 mm link length and a 40 mm height, the width of the cylindrical interface of the interlock/catch is 70 mm; the Mu_s is 0.2, and the loads applied on the frame side are a positive vertical load of 76 kN and a negative vertical load of -20 kN.

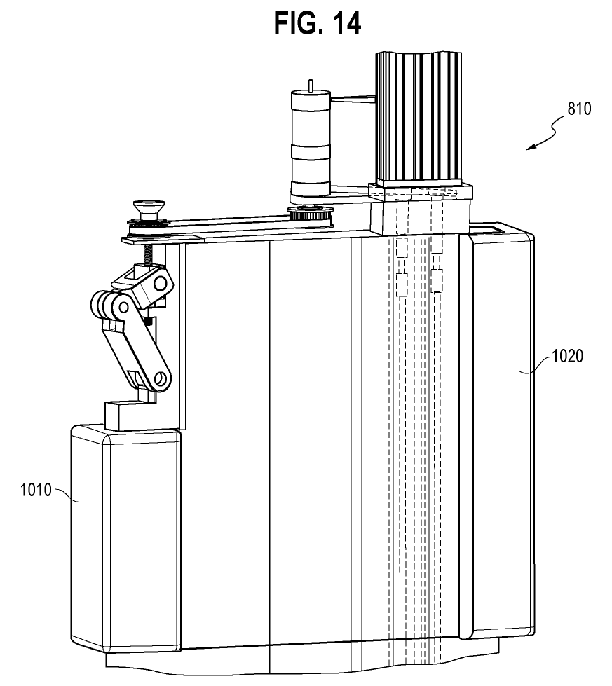

There are several alternatives that can be used with these embodiments. For example, as shown in FIG. 14, the strut 810 can have bearing blocks 1010, 1020 that can be replaced in the field. Wear of these bearing blocks 1010, 1020 can occur from “camming” when the hydrofoil slams into the water during landing (not from the locking mechanism).

In another alternative, instead of placing one or more catches in a casing or channel surrounding the strut, the catch can be part of a rail positioned adjacent the strut. While this alternative can be used with the front hydrofoil, it may also and/or instead be used with a rear hydrofoil, such as in an example where the rear hydrofoil hangs off the back of the craft and does not have a casing or channel surrounding it or in a channel. As such, a rail may be used as both a reinforcement mechanism and a guiding mechanism.

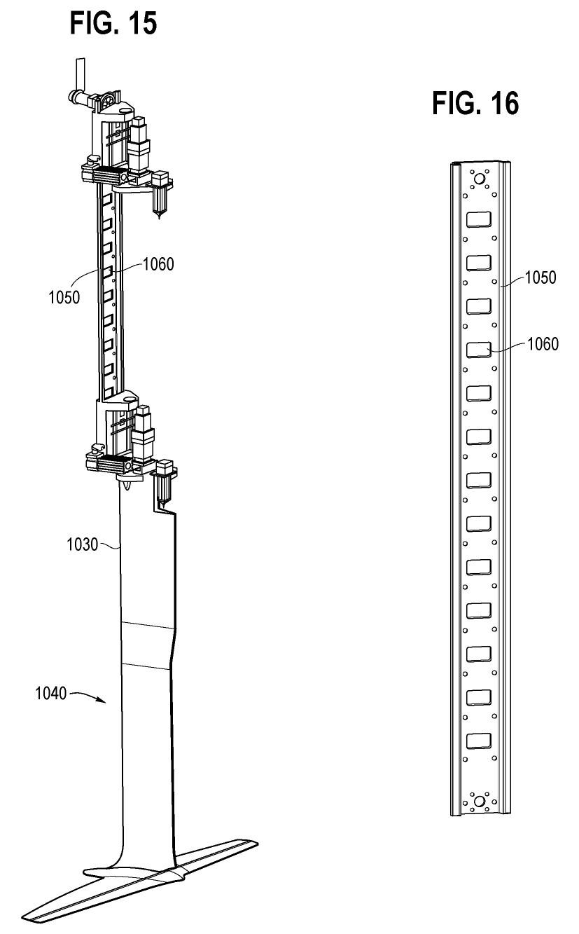

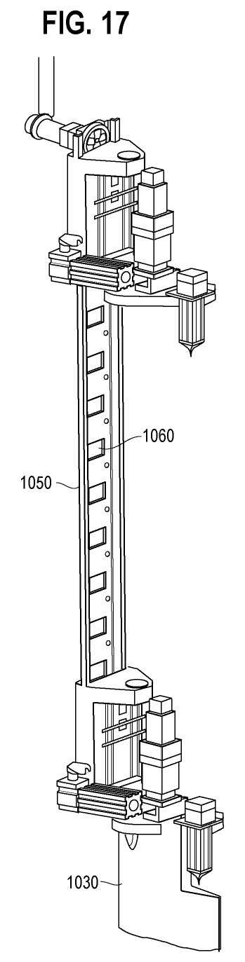

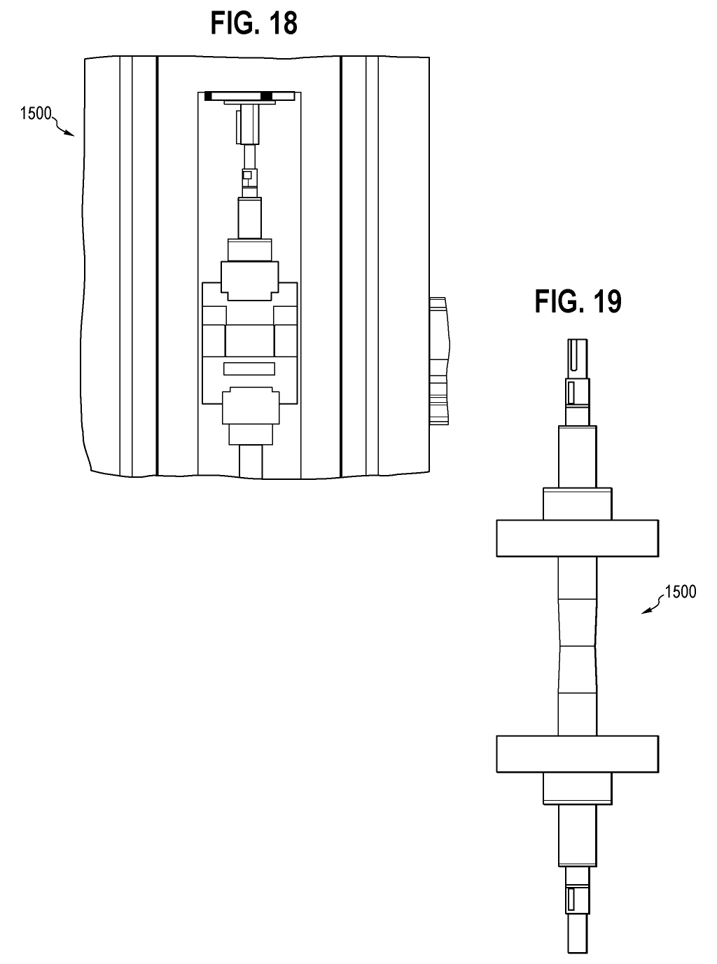

Such an alternative is illustrated in FIGS. 15-17. As shown in those drawings, the strut 1030 of the rear hydrofoil 1040 rides along a rail 1050 that comprises a plurality of catches 1060 (e.g., hardened inserts in the rail 1050), which act as discrete catch points along the duration of deployment path. While the catches 1060 are uniformly spaced in this example, it should be understood that alternative spacing (and number of catches 1060 on the rail 150) can be used. Further, as shown in FIGS. 18 and 19, in one embodiment, a twin leadscrew design 1500 is used for the rear hydrofoil, as loads are much lighter in the rear (e.g., only about 25% as much load as the front hydrofoil), and there are multiple points that are engaged.

FIGS. 18 and 19 depict a "twin leadscrew" arrangement as an alternative for driving movement of the interlock in connection with the rear rail/hydrofoil. Notably, the loads for the rear foil/configuration are much lighter than in the main foil, so there will be less stress (enabling use of the twin leadscrew). This twin leadscrew approach is generally designed to produce dual opposing motion using a single drive system (both top and bottom elements are moved using same drive). This one-piece screw delivers simultaneous right and left movement from a centerline. As the screw is turned, it causes both the top and bottom element to move towards one another (when screwed in one direction) and then to move away from one another (when screwed in other direction). This enables more rapid deployment of the interlock.

IV. Example Control Systems

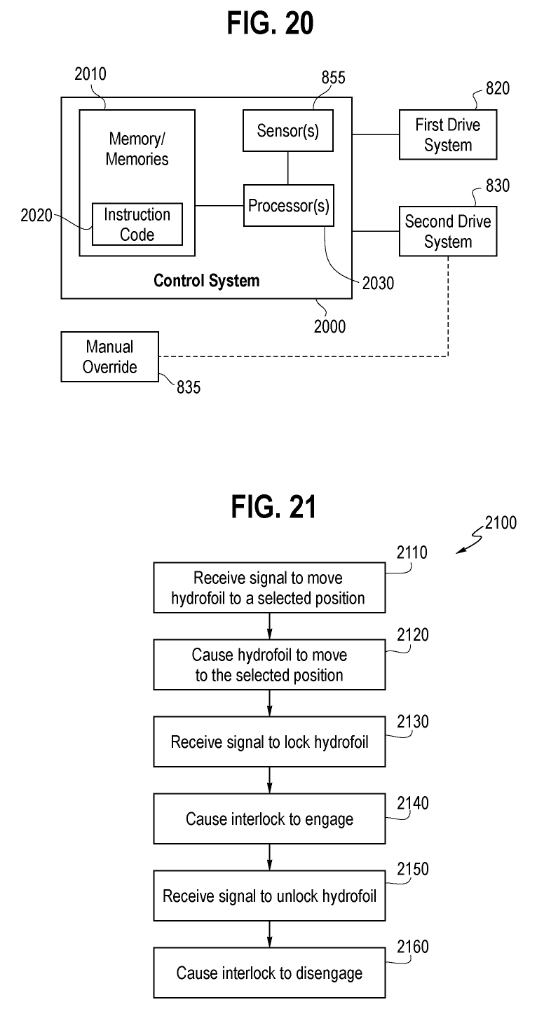

FIG. 20 is a block diagram of an example control system 2000 of an embodiment. As shown in FIG. 20, the control system 2000 comprises one or more non-transitory memories 2010 storing computer-readable instruction (program) code 2020, one or more processors 2030 configured to execute the program code 2020 to perform at least some of the functions described herein (and, optionally, other functions), and one or more sensors 855 (such as the ones discussed above). The control system 2000 is in wired or wireless communication (directly or through one or more components) with the first drive system 820 to move a hydrofoil between fully-retracted and fully deployed positions (and, optionally, in at least one intermediate position). The control system 2000 is also in wired or wireless communication (directly or through one or more components) with the second drive system 830 to selectively engage and disengage the interlock to selectively lock and unlock the strut of the hydrofoil in place. The manual override 835 can be used to manually operate the second drive system 830.

FIG. 21 is a flow chart 2100 of an example method that can be performed by the controller system 2000. As shown in FIG. 21, the control system 2000 receives a signal to move the hydrofoil to a selected position (act 2110). The signal can be generated, for example, by an operator interacting with a user input element in the cockpit of the craft. Alternatively, the signal can be generated automatically, e.g., at takeoff once craft is determined to me “off water”). Next, the control system 2000 causes the hydrofoil to move to the selected position by sending a control signal to the first drive system 820 (act 2120). Then, the control system 2000 receives a signal to lock the hydrofoil in place (act 2130). This signal can be automatically generated (e.g., when the sensor(s) 855 detect that the hydrofoil is in the selected position or by a sensor internal to the first drive system 820). In response, the control system 2000 causes the interlock to engage by sending a control signal to the second drive system 830 (act 2140). As noted above, as part of this process, the control system 2000 may cause the hydrofoil to slightly/iteratively move during deployment of the lock. That is, when the convex coupling portion is inserted into the recess of the catch, there can be a slight arc (vertical movement) of the convex coupling portion that inserts into the catch. So, during deployment, the hydrofoil can be moved slightly upward (e.g., two millimeters or less). After the control system 2000 receives a signal to unlock the hydrofoil (act 2150), the control system can cause the interlock to disengage by sending another signal to the second drive system (act 2160).

V. Example Shear Pin Architecture Implementation

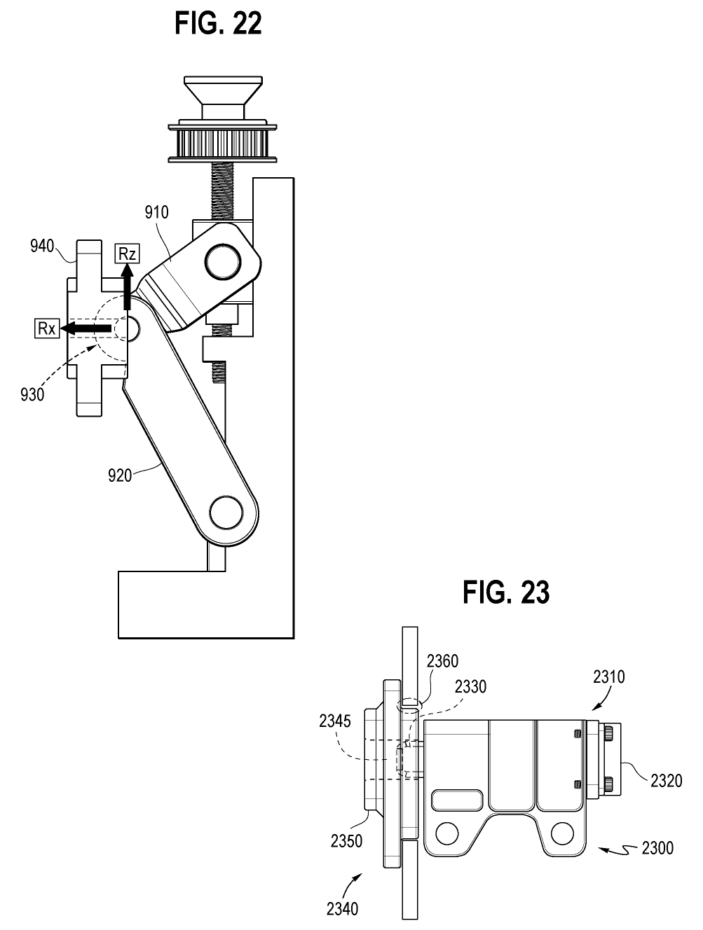

The example embodiment described above has the advantage of reducing the possibility of mechanical jamming and wear-and-tear issues over time. This is due to the use of a convex coupling portion with a spherical (convex), half-cylinder surface to interface with a corresponding spherical (concave), half-cylinder surface of a catch. With reference to FIG. 22, the convex coupling portion 930 formed at the intersection of the first and second arms 910, 920 provides horizontal (Rx) and vertical (Rz) force components when engaging the catch 940. In general, a greater Rx force decreases the likelihood that the convex coupling portion 930 will jam and not engage the catch 940. However, in some environments, it may be desired to use a lower Rx force. For example, in some environments, it may be challenging to predictably resolve the Rx force in an unsupported space. In some such situations, it may be desirable to use a relatively-lower Rx force.

For example, the length of the second arm 920 can be reduced to change the angle at which the convex coupling portion 930 engages the catch 940. In one example implementation, changing the angle from 30 degrees to 20 degrees can reduce the Rx force from 102 kN to 64 kN.

As another example, the geometry of the catch can be changed instead of, or in addition to, reducing the angle at which the coupling portion 930 engages with the catch 940. In one example implementation, instead of a simple cylindrical cross-section, the catch can be configured with two different shoulders, where the radius of the catch is smaller towards the middle than it is on the outsides, which can reduce the Rx force and increase the Rz force.

Alternatively, a different type of interlock in the hydrofoil locking system that exhibits a reduced Rx force may be used. For example, instead of using the two-arm design described above, the interlock can use a pin that is movable primarily along a single axis in engaging/disengaging a portion in the catch that is shaped to receive the pin. In this way, the pin, with its single-axis geometry, functions similar to a dead-bolt lock in some aspects, such as in that it slides into a “catch position” and then out. As used herein, a “pin” (which is sometimes referred to herein as a “draw bar”) broadly refers to a protrusion of any suitable size and shape (e.g., not necessarily a cylindrical shape). In one example implementation, the pin takes the form of a shear pin. Also, the portion in the catch that is shaped to receive the pin can be shaped in any suitable way (e.g., not necessarily in a mating shape with respect to the shape of the pin).

The following paragraphs describe an example implementation of this embodiment. It should be understood that this is merely an example and that other implementations can be used. As such, the details presented herein should not be read into the claims unless expressly recited therein. It should also be understood that this embodiment can be used alone in or combination with other embodiments presented herein (e.g., these embodiments can be used with the drive system described above to move hydrofoil strut between a plurality of deployment positions).

Turning again to the drawings, FIG. 23 is a diagram of a hydrofoil locking system 2300 of an embodiment. While the hydrofoil locking system 2300 in this example is used to lock a front hydrofoil of a craft, it should be understood that this system 2330 can also or instead be used to lock any other hydrofoil of a craft including, for example, a rear hydrofoil of a craft. As shown in FIG. 23, this system 2300 comprises an interlock 2310, a drive system 2320, and a catch 2340 fixed (e.g., in a foil-case wall) with respect to a hydrofoil strut carrying the interlock 2310. The interlock 2310 comprises a pin 2330, and the catch 2340 comprises a portion 2345 shaped to receive the pin 2330. The drive system 2320 (e.g., a servo motor) is configured to selectively move the pin 2330 along a single axis, including between first and second positions along the single axis, to cause the pin 2330 to move respectively in and out of engagement with the portion 2345 of the catch 2340 to selectively lock and unlock the strut in place when the strut is in one of a plurality of deployment positions. Vertical loads are transferred through a shoulder 2360. In this implementation, the catch 2340 comprises a removable plate 2350, which can cover a manual override access port. The removable plate 2350 can also contain a sensor (e.g., a proximity sensor) configured to sense when the portion 2345 of the catch 2340 receives the pin 2330 of the interlock 2310 (e.g., to verify the position of the pin 2330).

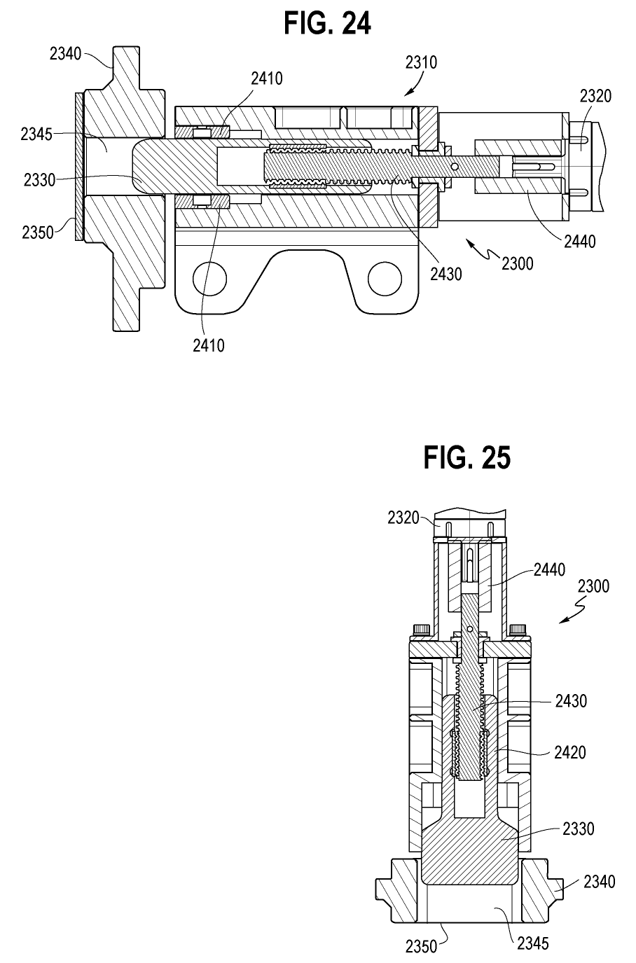

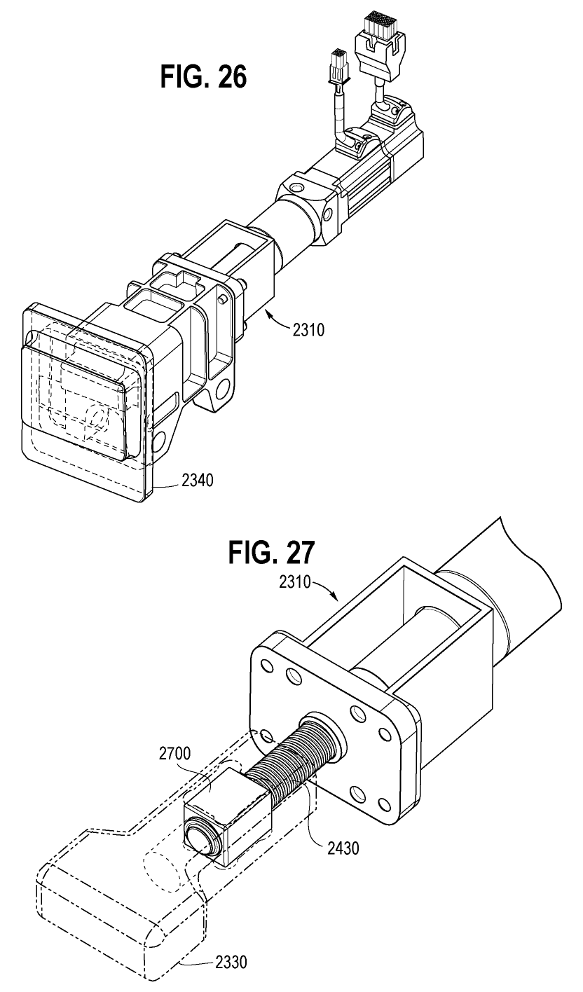

FIGS. 24 and 25 are cross-sectionals views of the hydrofoil locking system 2300 of this example embodiment, FIG. 26 is a perspective view of a portion of the locking system of this embodiment, and FIG. 27 is a perspective view of a portion of the locking system of this embodiment wherein a catch and a cover of a pin are removed to expose inside mechanics of the pin. As shown in these drawings, in this example implementation, the interlock 2310 comprises a pin 2330 constrained via bushings 2410, a leadscrew 2430 coupled with the captive (leadscrew) nut 2420 and drive system 2320. The interaction between the leadscrew 2430 and the captive nut 2420 is a helical thread engagement, which is a sliding-contact interaction. The captive nut 2420 is constrained from rotation about the leadscrew axis as well as translation in the screw-axial directions relative to the pin 2330, both via bounding geometry in the pin 2330 (i.e., a pocket feature). This, in turn, causes the input rotational motion of the leadscrew 2430 to be converted into translational motion along the leadscrew axis, imparted to the pin 2330 through axial force developed and transmitted through the sliding-thread interaction of the captive nut 2420. Those of skill in the art will appreciate that, in other example implementations, alternative techniques and/or elements may be used to move the pin along the axis.

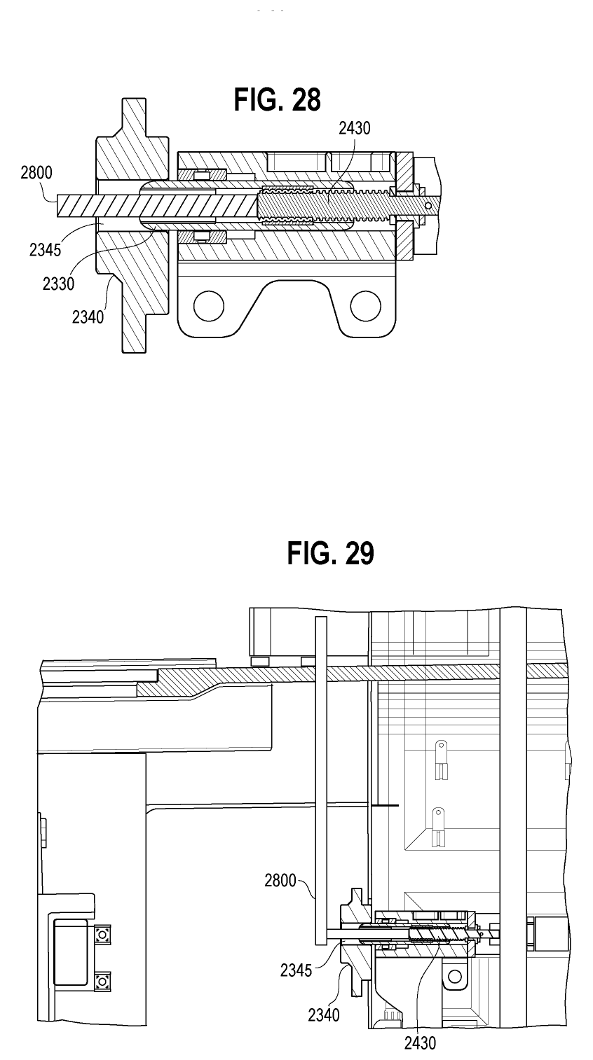

As mentioned above, the catch 2340 in this example has a removable plate 2350, which can cover a manual override access port. FIGS. 28 and 29 illustrate the manual override feature of this embodiment. As shown in these drawings, after the removable plate 2350 is removed, a user can insert a tool 2800 into the port/opening. The tool 2800 can pass through the catch 2340 and pin 2330 and interface with the leadscrew 2430. The tool 2800 can take the form of a ratchet tool, which the user can use to manually turn the leadscrew 2430 to move the pin 2330 back to its initial, retracted position to disengage the catch 2340. Similarly, the tool 2800 can be used to drive the leadscrew 2430 to move the pin 2330 into the extended position to engage the catch 2340. In one example implementation, the override is for use only when the craft is docked, and the override is not used to resolve a jam that happens while the craft is flying in the air, in which case the craft can land on the foils. In other example implementations, the override can be used while the craft is flying in the air.

It should be noted that the pin in this embodiment may need a relatively-higher actuation force for movement as compared to the two-arm, convex-coupling-portion design described above. For example, if the hydrofoil is essentially “hanging” on the catch while in a locked position, a relatively-high level of friction may be needed to be overcome in order to make the pin move (and unlock the foil) (i.e., the pin has no “desire”/tendency to self-escape). Also, axial loads (up and down, especially down) can be relatively high, and the catch 2340 can be designed in a way to handle those axial loads. For example, the catch 2340 can have a relatively-large surface area. The desire for a broad surface of the catch 2340 may be driven by a need to satisfy a high factor of safety, as increasing the surface area helps mitigate the “Hertzian contact stress” (i.e., stress between two mating surfaces).

The components in this embodiment can be sized in any suitable way. For example, the components can be designed using a minimum factor of safety of 2.5. “Factor of safety” refers to the ultimate load of the material divided by the limit load that will be experienced in the field. Factor of safety (FoS) can be calculated using the formula: FoS = Ultimate Stress / Allowable Stress. The leadscrew and drive train, for example, can be designed for a force margin of 125%. “Force margin” refers to the ratio between the driving forces and the resisting loads.

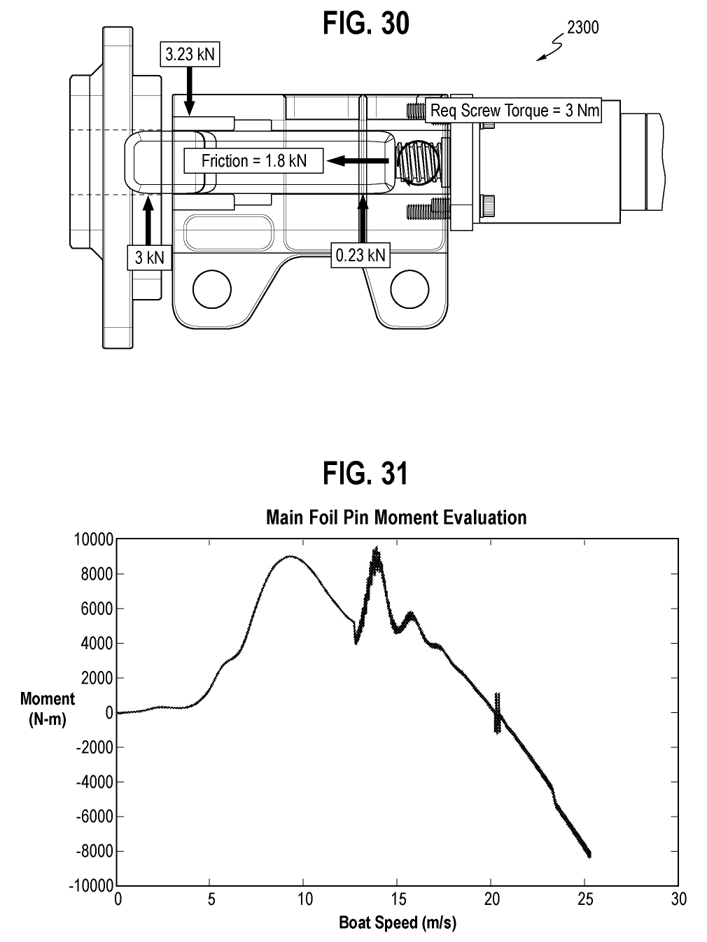

Also, the drive/actuation system can be “over engineered” in anticipation of dealing with a potential loading due to partial jamming, such that the drive/actuation system is able to pull the pin 2330 out of the catch 2340 if the pin 2330 gets bent or stuck. FIG. 30 presents an example of the forces that might be required in a situation where there is a jam (a “hung foil mass” situation). In this example, which assumes 85% motor and gearbox efficiency, the peak drive torque is 11.6 Nm, and the torque margin is 8.6 Nm.

VI. Examples of Managing “Racking” of Foil Within Case

The pin design can have an additional degree of freedom as compared to the two-arm, convex-coupling-portion design described above. That is, the pin only loads along the horizontal direction while the convex coupling portion loads along both the horizontal and vertical directions. Also, because the two-arm, convex-coupling-portion design is configured to “pivot,” the hydrofoil would be pressed up against the opposing cases and not allowed to move in any direction while locked. In contrast, with the pin design, while foiling, both a lift force and a drag force act on the hydrofoil. This results in a moment arm from drag (working in one direction) and a moment arm from lift (working in another direction). The direction of lift/drag does not change throughout the acceleration, but the lift/drag ratio does. While foiling, there is a speed at which the sum of the moment arms (from lift and drag) equal zero.

There are two static equilibriums in the system, and, operationally, the craft crosses over them as the craft speeds up, such as during acceleration of a takeoff procedure. When the moment from lift is greater than drag, the system will be “rocked forward.” Then, when the speed threshold is crossed, the system will resettle, and the foil will become “rocked backward” (e.g., about half a degree of foil deflection). This means that given whatever “clearance” there is within the casing that houses the strut, the strut will move forward and backward, hitting the casing and thereby creating banging noises, which is referred to herein as “racking.” Undesirably, such racking can be disruptive/uncomfortable and cause damage to the foil strut. (Racking may not be an issue with the two-arm, convex-coupling-portion design, if, when locked in place, the foil strut is pressed up against the housing wall and held there.)

Several techniques can be used to help manage racking. For example, a craft manufacturer can manipulate/engineer where the crossover point happens in speed, such that low speed is a “non-event.” The goal would be to ensure that the foil does not start banging against the casing after the crossover happens due to a divergent control loop, which can damage hardware and be disruptive to passengers of the craft.

In general, as speed increases, the lift-to-drag ratio changes. The pin moment of the main foil begins positive, and then in some instances there are about two points where it crosses over from positive to negative (e.g., around 13 mph and 20 mph in one example). This corresponds to a racking event. As the craft increases speed and approaches takeoff, the lift-to-drag ratio drops significantly.

As also shown in the graph of FIG. 31, as the craft’s speed while foiling increases, the sum of the moments gradually increases, then decreases and increasing again, returns to zero, and then ultimately turns negative. In other words, the strut racks once, speeds up, racks again, and then stays pinned to the other side of the casing. The example shown in FIG. 31 is but a single example of behavior; performance variables (e.g., craft and environment) can change the exact behavior of the craft in a given instance. It is possible to design the system so as to manipulate where, relative to speed, the cross-over to zero happens by manipulating the lift-to-drag ratio characteristic of the foil.

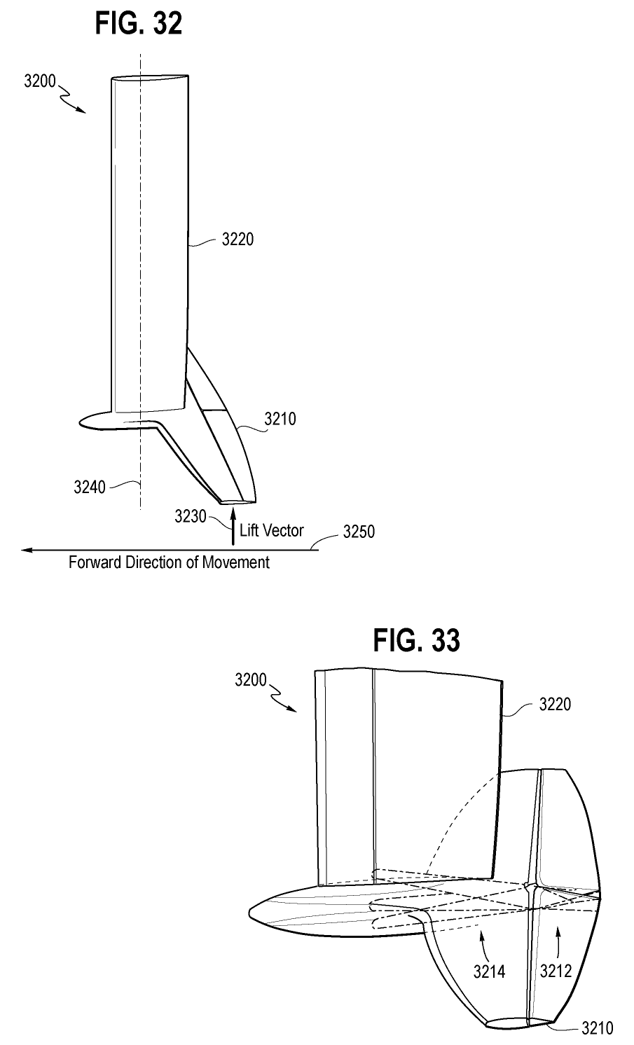

Also, a structural solution can be used to help manage forces on foil strut while foiling; namely, changing the geometry of the foil. As shown in FIGS. 32 and 33, one embodiment moves the position of the foil 3210 relative to the strut 3220 backwards, so that the lift vector 3230 is off-center with respect to the vertical axis 3240 of the strut 3220. This arrangement works to more-strongly push the strut 3220 against one side of the casing. As a result, the strut 3220 will always be on the “negative side” of the pin moment, regardless of the craft speed while foiling. In this arrangement, as a result of the adjusted foil position, the strut of the foil is always pushed adjacent the rear of the casing (i.e., the side of the casing that is opposite the forward direction of movement 3250). FIG. 33 demonstrates that because the foil is now “off center” with the main foil vertical axis, the control surfaces of the foil are behind the vertical axis. As a result, in this embodiment, a new spar 3212 has been added and the longer “rocker arms” 3214 are introduced to translate the actuation mechanism for the control surface to the displaced/ relocated foil. In one embodiment, the craft can comprise a second control-surface actuator that connects the first control-surface actuator to a control surface of the hydrofoil. The craft can also comprise a spar element that extends along an internal surface of the hydrofoil, wherein the second control-surface actuator extends past the spar element through an internal space of the hydrofoil.

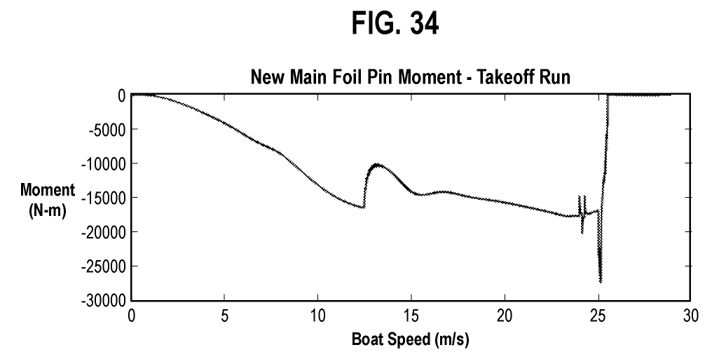

In one example implementation, the rocker arm 3214 length changes from 320 mm to 519 mm on the starboard side and from 285 mm to 484 mm on the port side. The maximum hinge moment increases from 1,518 N-m to 2,579 N-m. Further, the effector speed decreases from 38 degrees/second to 23.4 degrees/second, and the range decreases from 30.2 degrees to 16.6 degrees. Because the control surfaces of the foil are “off center” from the control/actuation lever in this embodiment, the spar (wing beam) section 3212 to the foil can be modified to provide reinforcement if the middle of foil is hollowed out to enable the rocker arms 3214. That is, instead of using a reinforcement spar that goes through the body of the foil in front of the actuation elements, two separate spars can be used that are positioned so as to avoid the rocker arms. As shown in the graph of FIG. 34, in this example implementation, the moment remains less than 0 at all speeds and is immediately negative even at very low speed, thus obviating the “racking” phenomenon.

VII. Example Rear Foil

A. Overview

As mentioned above, the shear pin architecture described in the previous section can be used with a front foil and/or a rear foil of a craft. This section provides an example of a shear pin architecture implemented in a rear foil. It should be understood that this is merely an example and that other implementations can be used.

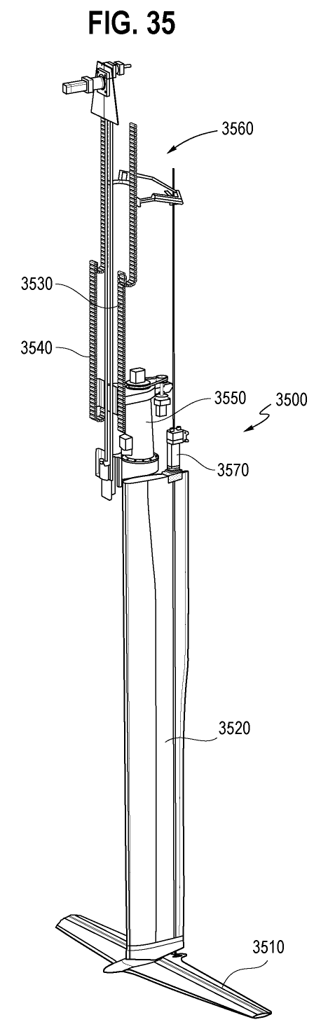

Turning again to the drawings, FIG. 35 is an example hydrofoil assembly 3500 of an embodiment. As shown in FIG. 35, in this example implementation, the hydrofoil assembly 3500 comprises a hydrofoil 3510 and a strut 3520. As will be described in more detail below, the strut 3520 is movable along two rails 3530, 3540, and the shear pin architecture described above is used to lock the strut 3520 (and hence the hydrofoil 3510) in place. The actuation system 3550 is configured to rotate the strut 3520 about an axis of rotation, which allows the strut 3520 to act as a rudder. The dual rail 3530, 3540 approach can enable use of robust equipment suitable for housing the long arm of the rudder and the robust actuation/drive system discussed below. In one implementation, the rear hydrofoil 3510 can retract into a rear case/body of the craft instead of being a simple strut, as with the front foil, and the case can be an extra lightweight surface that extends off the rear of the hull of the craft (e.g., a light shell “ferring”). Assembly 3560 is a lift-and-lower mechanism for deploying/retracting the overall hydrofoil assembly 3500.

B. Rear Foil Structure

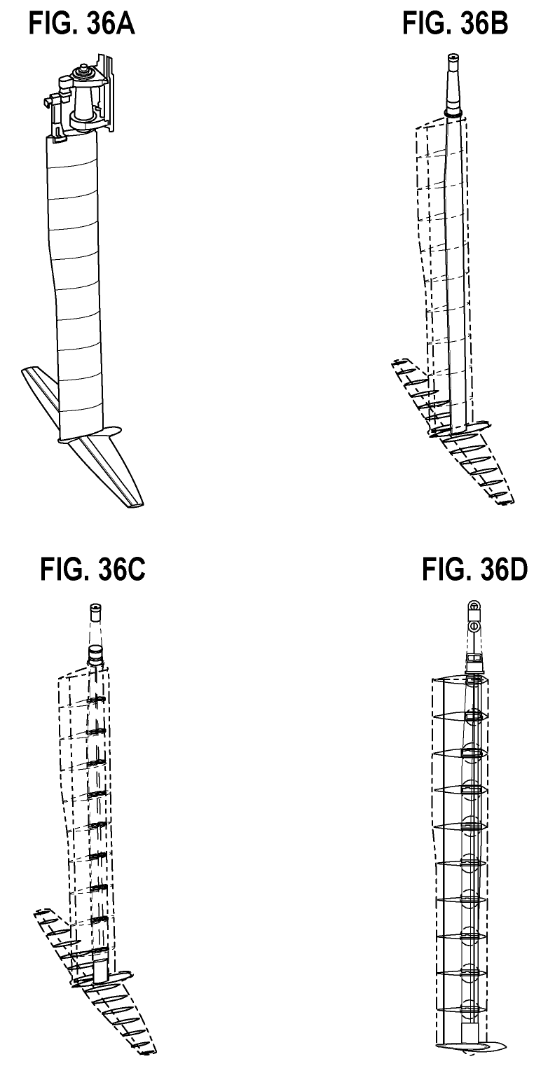

Turning again to the drawings, FIGS. 36A-36D are various views of the hydrofoil assembly 3500 that show various structural layers of the hydrofoil 3510 and strut 3520. In this embodiment, for both the front and rear foils, actuation hardware/components extend from the top of the strut down to the foil itself, at which point those components tie into actuators/components (that are local to the foil itself) that ultimately activate/control the control surfaces on the foil(s). In one example, the construction can contain ribs supporting the main structure and a hollow tube-like structure used to house a vertical connection between the craft and the hydrofoil (e.g., for actuation, communication elements, etc.)

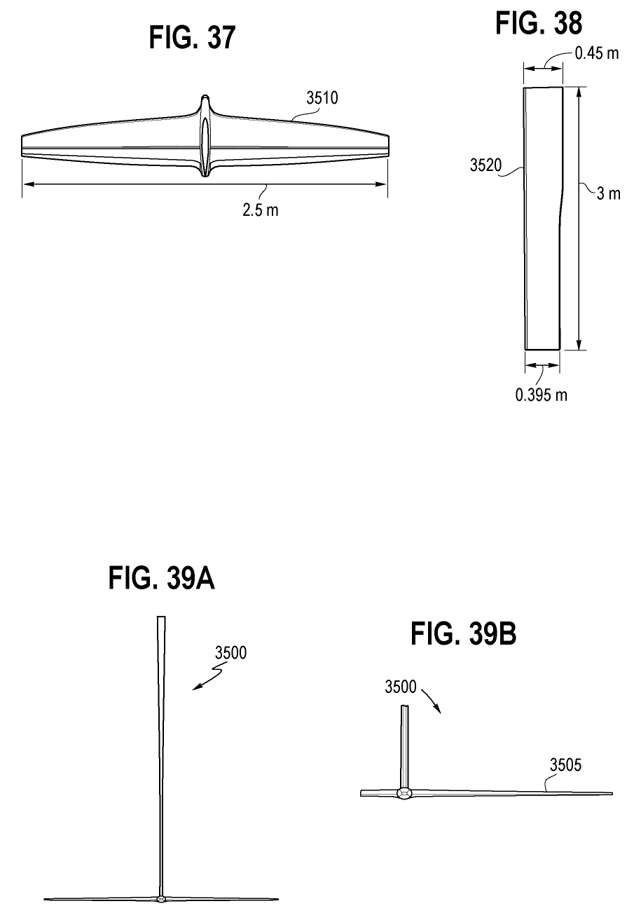

FIG. 37 is a top view of the hydrofoil 3510, and FIG. 38 is a side view of the strut 3520. As shown in these figures, in this example embodiment, the hydrofoil 3510 has a width of 2.5 meters, and the strut 3520 has a top width of 0.45 meters, a bottom width of 0.395 meters, and a length of 3 meters. The design includes a -1.5 degree incident angle, a light 0.005 camber in the flap, a triangular/elliptical chord distribution mix (e.g., 143.1 mm at the top, 570 mm at the bulb tip, and 350 mm at the bulb root), a flap range of +/- 12 degrees, a slew rate up of 90 degrees/second, and a hinge moment capability of 360 N-m continuous and 719 N-m peak. It should be understood that, within examples, the hydrofoil, strut and rudder, and/or hydrofoil assembly may be characterized by different dimensions and sizes of various components.

FIGS. 39A and 39B are front and side views, respectively, of the hydrofoil system 3500 of this example embodiment. With reference to FIG. 39A in these figures, in this example, the strut/rudder 3520 thickness tapers from 19% t/c to 12%, with a constant 12% t/c at the bottom 0.9 meters of the strut 3520 (lower t/c provides less cavitation and drag). With reference to FIG. 39B, there is a small thickness bulge 3505 near outermost flap hinge hardware. It should be understood that, within examples, the hydrofoil system and/or strut and rudder may be characterized by different dimensions and sizes of various components.

This design has a relatively-high span-to-chord aspect ratio. For example, in one implementation, the top of the strut 3520 has a 450 mm cord length (depth) and tapers down to a 395 mm cord length, which is a relatively-short cord length. The result is a relatively “tall and skinny” rudder. Regarding the size of the hydrofoil 3510, if the craft can travel ~13 Knotts in the water, the amount of rudder left in the water when foiling at that speed is about 1.2 to 1.5 meters. It may be desired to have relatively-low drag to maximize takeoff speed. For example, from 13 to 15 Knotts, the craft may not need any more lift at that speed. To minimize drag, the bottom 1.2 meters of the strut 2530 can be made thinner (to reduce the thickness-to-cord ration). At the same time, in this state (foiling at high speed), all of the force is at the bottom of the strut 3520 far away from where the strut 3520 connects to the rails 3530, 3540, which means a very strong moment/rotational force is being created. So, the thickness/size of the upper 1.8 meters of the strut 3520 (e.g., the portion out of the water) can be increased to increase the thickness of that portion of the strut 3520 to help react that force. That is, the design/dimensions of the bottom 1.2 meters of the strut 3520 can be “aerodynamically driven,” while the top 1.8 meters of the strut 3520 can be structurally/strength driven. The particular dimensions of the strut 3520 in any given implementation can be based on craft size and multi-mode operation requirements (e.g., hull borne and foil borne operations), with these design considerations (and others) in mind. Other examples of suitable dimensions may exist.

Also, the rudder length (i.e., along the vertical dimension) of the strut 3520 can be based on ride height while foiling, while width and other dimensions can be based on optimizing drag for hull and foil mode operations. For example, the rudder planform and foil sections can be sized to achieve lift/drag targets across all conditions, and the elevator planform and foil sections can be sized to achieve lift/drag targets across all conditions. The rudder foil sections can be scaled to achieve structure requirements along full length of span, and rudder stock can be designed for stress, deflection, and compatibility with the steering/lifting system. The flap actuation system can be designed for operations across an intended range of operations, and the elevator stiffness can be optimized. Further, the steering and pushrod actuation systems can be designed for operation across an intended range of operation

C. Actuation System

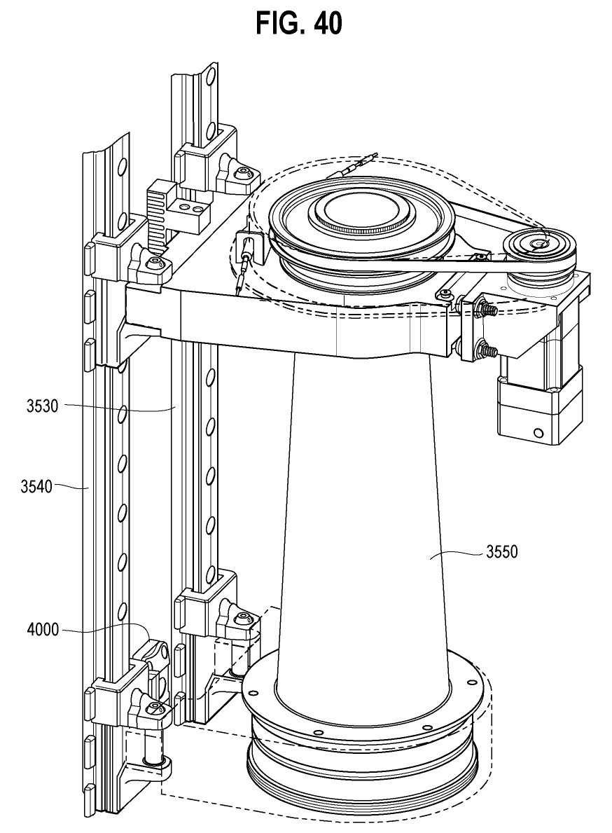

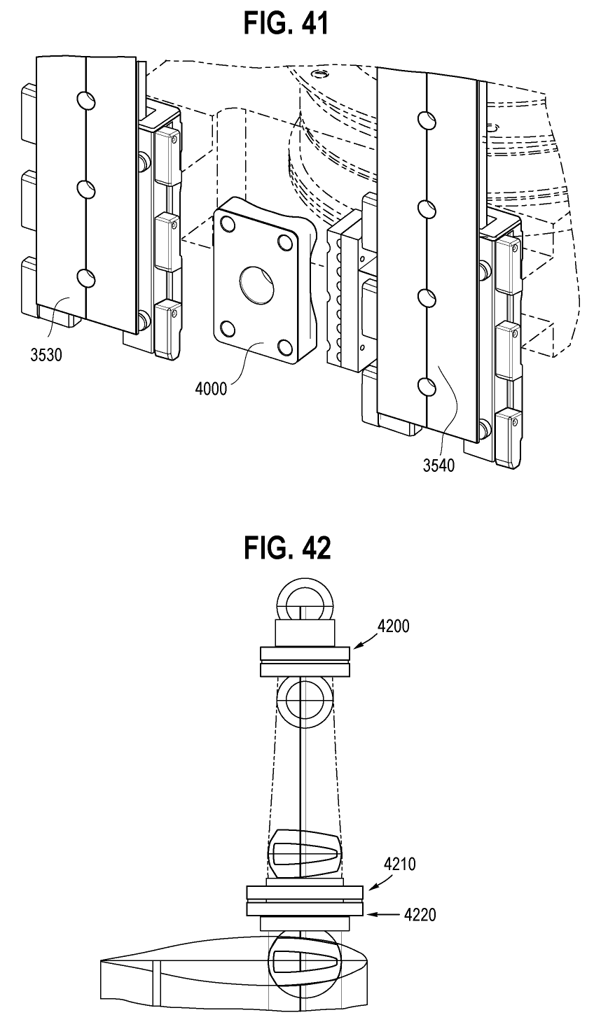

As mentioned above, the actuation system 3550 in this example embodiment is configured to not only move the strut 3520 up and down between deployed and retracted positions but is also configured to rotate the strut 3520 about an axis, which allows the strut 3520 to act as a rudder. As explained in conjunction with FIG. 35 and as shown in more detail in FIGS. 40 and 41, in this example embodiment, the actuation system 3550 (which is coupled to the strut 3520 and hydrofoil 3510) is configured along two rails 3530, 3540 between deployed and retracted positions, and the shear pin architecture can be used to insert a pin into a catch 4000 to lock actuation system 3550 into position. In this example, the rear hydrofoil assembly 3550 is movable between only two positions. However, it should be noted that other configurations are possible, and that the hydrofoil assembly 3550 might in other examples be movable between three or more positions. Also, in this example implementation, in addition to the actuation system 3550, this design includes two additional actuation components 3570: (1) a rear hydrofoil control surface (“hydrovator”) actuator and mount assembly (which controls the control surfaces on the hydrofoil itself) and (2) a hydrodynamic rudder (steering) actuator.

The top of the strut 3520 is shaped to be received in the cone-like structure of the actuation system 3550. As shown in FIG. 42, the top of the strut 3520 is coupled with the actuation system 3550 via an upper bearing 4200, and the bottom of the strut 3520 is coupled with the hydrofoil 3510 via a lower bearing 4210 adjacent to a thrust plane 4220. In this example embodiment, the strut/rudder 3520 sticks out from bottom of the casing (bearing cavity). At top and bottom of the casing are spherical roller bearings 4200, 4210 holding the rudder 3520. The top shoulder is pulled into tension by the top pulley, and a spline pulley is affixed to the headstock of the rudder.

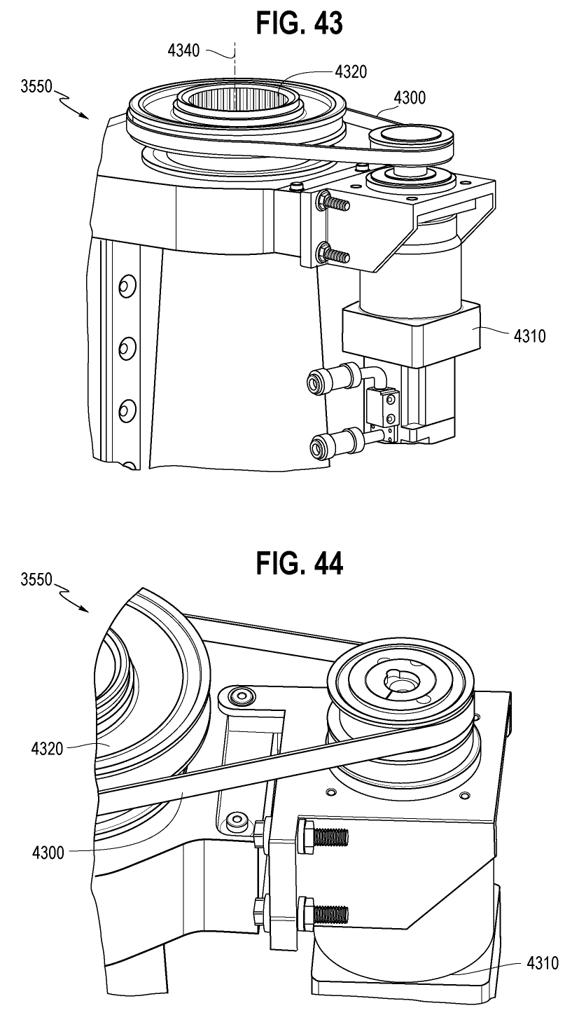

As shown in FIGS. 43 and 44, the actuation system 3550 of this embodiment comprises a belt 4300, motor 4310, and toothed pulley 4320. With this arrangement, the actuation system 3550 can rotate the strut 3520 about an axis of rotation 4340, thereby enabling the strut 3520 to function as a rudder.

In one example implementation, the design can be characterized by an hinge moment (HM) raw of 163 Nm, an actuation limit load (LL) (i.e. maximum design load) of 204 Nm, and a structure LL of 408 Nm. Also, a splined pulley interface can be used to drive a gearbox and the driven pulley to a rudder sleeve. A belt tensioner can be integrated into the drive unit mount, and a gearbox direct spline drive with no stub shaft can be used. The belt can be a 12 mm, 8M GT carbon toothed belt, and the motor can be a 200 W drive motor with absolute position sensing. The final reduction can have a ratio of 136:1, and the total install tension can be 3 kN.

Accordingly, in this example embodiment, the rear combined strut and rudder has three primary “actuation” components that: (1) deploy/retract the strut and rudder along rails, (2) control rotation (yaw) of the rudder, and (3) control control surfaces (such as the elevator and/or flap) on the foil itself. The power transmission belt is driven by a “planetary reduced” servo motor. The system has mechanical advantages, has shock and misalignment tolerance, and is weather resistant/adverse. Shock and misalignment tolerance is desired because the rudder is relatively very long compared to size of the casing, and robustness provides deflection. The bearings are preferably able to misalign relative to one another by a full degree. The pulley and belt system is preferably flexible in response to flexion of the rudder, which is why a more-flexible pulley system may be desired.

The system helps the craft perform well despite operational challenges including those associated with landing such as that when the craft is landing, if the craft is not directly aligned with flow of the water, the rudder will automatically align with the true flow of water (so as to not cause a major disruption). In other words, it is desirable that, when landing, the rudder be capable of “feathering.” So, in one example implementation of this design, it does not use, for example, a gear-to-gear transmission and is relatively “back drivable” compared to other possible approaches. (In other example implementations, any other type of drive mechanism might be used.) Accordingly, in one example approach, when landing, the rudder control is placed in a neutral state.

Alternatively, in another example approach, the rudder might not be placed in a fully neutral state. Together with this approach, the drive torque of the system may be controlled and/or limited such that the maximum vehicle moments are controlled and/or limited and correspondingly the amount of “back drive” on the transmission is controlled and/or limited. Such an approach enables ongoing control of the rudder.

In any event, after landing, physical control of the rudder is reestablished (or may have already been established and/or maintained). In this example, the rudder is controllable even when “stowed” (i.e., in the “retracted” position), as it is desired to be able to control for beta angle and feathering when landing, as discussed above. Also, it may be desired to “turn on” active control of rudder right away after landing without needing to stop the craft and deploy the rudder into the deployed position.

VIII. Examples

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.

Example 1. A craft comprising: a hydrofoil assembly comprising a hydrofoil and a strut, wherein the hydrofoil is positioned such that a lift vector created by the hydrofoil is positioned rearward of a vertical axis of the strut with respect to a cockpit of the craft; a first drive system coupled with the strut and configured to move the strut between a plurality of positions; and a hydrofoil assembly locking system comprising: a second drive system; an interlock comprising a pin coupled with the second drive system; and a catch comprising a portion shaped to receive the pin; wherein the second drive system is configured to selectively move the pin along a single axis between first and second positions to cause the pin to move respectively in and out of engagement with the portion of the catch to selectively lock and unlock the strut in place when the strut is in one of the plurality of deployment positions.

Example 2. The craft of the preceding Example, wherein the interlock further comprises: a captive nut coupled with the pin; and a leadscrew coupled with the captive nut; and the second drive system comprises a servo motor coupled with the leadscrew.

Example 3. The craft of any of the preceding Examples, wherein the pin comprises a shear pin.

Example 4. The craft of any of the preceding Examples, further comprising a sensor configured to sense when the portion of the catch receives the pin.

Example 5. The craft of any of the preceding Examples, wherein the catch comprises a removable plate covering a manual override access port.

Example 6. The craft of any of the preceding Examples, further comprising: at least one additional catch fixed with respect to the strut and positioned to receive the pin to lock the strut in place when the strut is in at least one other deployment position.

Example 7. The craft of any of the preceding Examples, wherein the hydrofoil assembly comprises a front hydrofoil assembly of the craft.

Example 8. The craft of any of the preceding Examples, wherein the hydrofoil assembly comprises a rear hydrofoil assembly of the craft.

Example 9. The craft of any of the preceding Examples, further comprising: a first control-surface actuator that is substantially aligned with the vertical axis of the strut.

Example 10. The craft of any of the preceding Examples, further comprising: a second control-surface actuator that connects the first control-surface actuator to a control surface of the hydrofoil.

Example 11. The craft of any of the preceding Examples, further comprising: a spar element that extends along an internal surface of the hydrofoil, wherein the second control-surface actuator extends past the spar element through an internal space of the hydrofoil.

Example 12. The craft of any of the preceding Examples, wherein the spar element is a first spar element and the internal surface of the hydrofoil is a first internal surface of the hydrofoil, the craft further comprising a second spar element that extends along a second internal surface of the hydrofoil.

Example 13. The craft of any of the preceding Examples, further comprising a control surface, wherein the control surface is positioned rearward of the vertical axis of the strut with respect to the cockpit of the craft.

Example 14. The craft of any of the preceding Examples, wherein the hydrofoil assembly is a first hydrofoil assembly, the hydrofoil is a first hydrofoil, and the strut is a first strut, the craft further comprising: a second hydrofoil assembly comprising a second hydrofoil and a second strut; a third drive system coupled with the second strut and configured to move the second strut; and a fourth drive system coupled with the second strut and configured to rotate the second strut about an axis of rotation, wherein the second strut is affixed to the second hydrofoil so as to support the second hydrofoil.

Example 15. The craft of any of the preceding Examples, further comprising: a control system, wherein the control system is configured to: cause the fourth drive system to operate in a neutral state during a landing procedure so as to allow the second strut to rotate about the axis of rotation when the second strut initially contacts the water upon landing; and cause the fourth drive system to re-establish rotational control of the second strut after contacting the water upon landing.

Example 16. A craft comprising: a hydrofoil assembly comprising a hydrofoil and a strut; a first drive system coupled with the strut and configured to move the strut between a plurality of positions; and a second drive system coupled with the strut and configured to rotate the strut about an axis of rotation, wherein the strut is affixed to the hydrofoil so as to support the hydrofoil; a control system, wherein the control system is configured to: cause the second drive system to operate in a neutral state during a landing procedure so as to allow the strut to rotate about the axis of rotation when the strut initially contacts the water upon landing; and cause the second drive system to re-establish rotational control of the strut after contacting the water upon landing.

Example 17. The craft of any of the preceding Examples, further comprising dual rails along which the strut is movable between the plurality of positions.

Example 18. The craft of any of the preceding Examples, wherein the second drive system comprising a motor, a belt, and a pulley.

Example 19. The craft of any of the preceding Examples, further comprising: a hydrofoil assembly locking system comprising: a third drive system; an interlock comprising a pin; and a catch fixed with respect to the strut and comprising a portion shaped to receive the pin; wherein the third drive system is configured to selectively move the pin along a single axis between first and second positions to cause the pin to move respectively in and out of engagement with the portion of the catch to selectively lock and unlock the strut in place.

Example 20. The craft of any of the preceding Examples, wherein the interlock further comprises: a captive nut coupled with the pin; and a leadscrew coupled with the captive nut; and the third drive system comprises a servo motor coupled with the leadscrew.

Example 21. The craft of any of the preceding Examples, wherein the pin comprises a shear pin.

Example 22. The craft of any of the preceding Examples, wherein the hydrofoil assembly comprises a rear hydrofoil assembly of the craft.

Example 23. The craft of any of the preceding Examples, wherein the hydrofoil is positioned such that a lift vector created by the hydrofoil is positioned rearward of a vertical axis of the strut with respect to a forward direction of travel of the craft.

Example 24. A method comprising: performing in a craft: moving a front hydrofoil assembly of the craft to a first deployment position, wherein the front hydrofoil assembly comprises a front strut and a front hydrofoil; moving a first pin into a first catch to lock the front strut in place in the first deployment position; moving a second hydrofoil assembly to a second deployment position, wherein the second hydrofoil assembly comprises a second strut and a second hydrofoil; moving a second pin into a second catch to lock the second strut in place in the second deployment position; allowing the second strut to freely rotate when the second strut initially contacts water upon landing; and causing rotation of the second strut after landing, wherein the second strut serves a dual-purpose of supporting the second hydrofoil and functioning as a rudder of the craft when the second strut is in the water.

Example 25. The method of the preceding Example, wherein the front hydrofoil is positioned such that a lift vector created by the front hydrofoil is positioned rearward of a vertical axis of the front strut with respect to a forward direction of travel of the craft.

Example 26. The method of any of the preceding Examples, wherein the first and second pins comprises respective shear pins configured to move along a single axis.

Example 27. The method of any of the preceding Examples, wherein the second strut moves along dual racks.

Example 28. A craft comprising: a hydrofoil comprising a strut; a first drive system coupled with the strut and configured to move the strut between a plurality of deployment positions; and a hydrofoil locking system comprising: a second drive system; an interlock comprising: a first arm comprising a first end rotatably coupled with the second drive system; and a second arm comprising a first end rotatably coupled with the strut; wherein the first and second arms further comprise respective second ends that are rotatably coupled together and form a convex coupling portion; and a catch fixed with respect to the strut and comprising a concave portion; wherein the second drive system is configured to selectively move the first end of the first arm between first and second positions, which causes the convex coupling portion of the interlock to move respectively in and out of engagement with the concave portion of the catch to selectively lock and unlock the strut in place when the strut is in one of the plurality of deployment positions.

Example 29. The craft of any of the preceding Examples, further comprising: at least one additional catch fixed with respect to the strut and positioned to receive the convex coupling portion of the interlock to lock the strut in place when the strut is in at least one other deployment position.

Example 30. The craft of any of the preceding Examples, wherein the catch is part of a casing that at least partially surrounds the strut.

Example 31. The craft of any of the preceding Examples, wherein the hydrofoil comprises a front hydrofoil of the craft.

Example 32. The craft of any of the preceding Examples, wherein the catch is part of a rail positioned adjacent the strut.

Example 33. The craft of any of the preceding Examples, wherein the hydrofoil comprises a rear hydrofoil of the craft.

Example 34. The craft of any of the preceding Examples, wherein the first drive system comprises a belt drive.

Example 35. The craft of any of the preceding Examples, wherein the second drive system comprises a linear screw.

Example 36. The craft of any of the preceding Examples, wherein the second drive system comprises a manual override.

Example 37. The craft of any of the preceding Examples, further comprising a sensor configured to sense when the concave portion of the catch receives the convex coupling portion of the interlock.

Example 38. The craft of any of the preceding Examples, wherein the second arm is longer than the first arm

Example 39. A hydrofoil locking system comprising: a drive system; and an interlock comprising: a first arm comprising a first end rotatably coupled with the drive system; and a second arm comprising a first end configured to be rotatably coupled with a strut of a hydrofoil; and wherein the first and second arms further comprise respective second ends that are rotatably coupled together and form a convex coupling portion; wherein the drive system is configured to selectively move the first end of the first arm substantially parallel to a longitudinal axis of the strut between first and second positions, which causes the convex coupling portion of the interlock to move at least substantially perpendicular to the longitudinal axis of the strut.

Example 40. The hydrofoil locking system of the preceding Example, wherein the drive system comprises a linear screw.

Example 41. The hydrofoil locking system of any of the preceding Examples, wherein the drive system comprises a manual override.

Example 42. The hydrofoil locking system of any of the preceding Examples, wherein the second arm is longer than the first arm.

Example 43. A method comprising: performing in a craft comprising: a hydrofoil comprising a strut; a drive system; an interlock comprising: a first arm comprising a first end rotatably coupled with the drive system; and a second arm comprising a first end rotatably coupled with the strut; wherein the first and second arms further comprise respective second ends that are rotatably coupled together and form a convex coupling portion; and a catch fixed with respect to the strut and comprising a concave portion: selectively moving the first end of the first arm between first and second positions, which causes the convex coupling portion of the interlock to move respectively in and out of engagement with the concave portion of the catch to selectively lock and unlock the strut in place when the strut is in one of the plurality of deployment positions.

Example 44. The method of any of the preceding Examples, wherein the hydrofoil comprises a front hydrofoil of the craft.

Example 45. The method of any of the preceding Examples, wherein the hydrofoil comprises a rear hydrofoil of the craft.

Example 46. The method of any of the preceding Examples, wherein the drive system comprises a linear screw.

Example 47. The method of any of the preceding Examples, wherein the drive system comprises a manual override.

Example 48. The method of any of the preceding Examples, further comprising sensing when the concave portion of the catch receives the convex coupling portion of the interlock.

Example 49. The method of any of the preceding Examples, wherein the second arm is longer than the first arm.

IX. Conclusion

Various examples of systems, devices, and/or methods have been described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein. Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

While the systems and methods of operation have been described with reference to certain examples, it will be understood by those skilled in the art that various changes can be made, and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A craft comprising: a hydrofoil assembly comprising a hydrofoil and a strut, wherein the hydrofoil is positioned such that a lift vector created by the hydrofoil is positioned rearward of a vertical axis of the strut with respect to a cockpit of the craft; a first drive system coupled with the strut and configured to move the strut linearly along the vertical axis between a plurality of positions; and a hydrofoil assembly locking system comprising: a second drive system comprising a motor coupled with a leadscrew; an interlock comprising a pin coupled with the second drive system through the leadscrew; and a catch comprising a portion shaped to receive the pin; wherein the second drive system is configured to selectively move the pin linearly along a horizontal axis between first and second positions to cause the pin to move respectively in and out of engagement with the portion of the catch to selectively lock and unlock the strut in place when the strut is in one of the plurality of deployment positions, wherein the vertical axis is substantially perpendicular to the horizontal axis.

2. The craft of claim 1, wherein: the interlock further comprises: a captive nut coupled with the pin, wherein the leadscrew is coupled with the captive nut.

3. The craft of claim 1, wherein the pin comprises a shear pin.

4. The craft of claim 1, further comprising a sensor configured to sense when the portion of the catch receives the pin.

5. The craft of claim 1, wherein the catch comprises a removable plate covering a
manual override access port.

6. The craft of claim 1, further comprising: at least one additional catch fixed with respect to the strut and positioned to receive the pin to lock the strut in place when the strut is in at least one other deployment position.

7. The craft of claim 1, wherein the hydrofoil assembly comprises a front hydrofoil assembly of the craft.

8. The craft of claim 1, wherein the hydrofoil assembly comprises a rear hydrofoil assembly of the craft.

9. The craft of claim 1, further comprising: a first control-surface actuator that is substantially aligned with the vertical axis of the strut.

10. The craft of claim 9, further comprising: a second control-surface actuator that connects the first control-surface actuator to a control surface of the hydrofoil.

11. The craft of claim 10, further comprising: a spar element that extends along an internal surface of the hydrofoil, wherein the second control-surface actuator extends past the spar element through an internal space of the hydrofoil.

12. The craft of claim 11, wherein the spar element is a first spar element and the internal surface of the hydrofoil is a first internal surface of the hydrofoil, the craft further comprising a second spar element that extends along a second internal surface of the hydrofoil.

13. The craft of claim 1, further comprising a control surface, wherein the control surface is positioned rearward of the vertical axis of the strut with respect to the cockpit of the craft.

14. The craft of claim 1, wherein the hydrofoil assembly is a first hydrofoil assembly, the hydrofoil is a first hydrofoil, and the strut is a first strut, the craft further comprising: a second hydrofoil assembly comprising a second hydrofoil and a second strut; a third drive system coupled with the second strut and configured to move the second strut; and a fourth drive system coupled with the second strut and configured to rotate the second strut about an axis of rotation, wherein the second strut is affixed to the second hydrofoil so as to support the second hydrofoil.

15. The craft of claim 14, the craft further comprising: a control system, wherein the control system is configured to: cause the fourth drive system to operate in a neutral state during a landing procedure so as to allow the second strut to rotate about the axis of rotation when the second strut initially contacts the water upon landing; and cause the fourth drive system to re-establish rotational control of the second strut after contacting the water upon landing.

16. The craft of claim 1, wherein: the interlock further comprises a captive nut coupled with the pin and coupled with the leadscrew; wherein rotation of the leadscrew by the motor causes translational motion of the captive nut along the horizontal axis, and the translational motion of the captive nut is imparted to the pin through a sliding-thread interaction between the captive nut and the leadscrew.

17. The craft of claim 11, wherein the interlock further comprises one or more bushings constraining the pin, wherein the one or more bushings guide the pin along the horizontal axis.

18. The craft of claim 1, wherein the hydrofoil assembly locking system further comprises a shoulder configured to transfer vertical loads between the strut and a structure of the craft when the pin is engaged with the portion of the catch.

19. The craft of claim 1, wherein the catch comprises a removable plate covering an access port, wherein the access port is configured to receive a tool that passes through the catch and the pin to interface with the leadscrew, whereby rotation of the leadscrew by the tool causes the pin to move between the first and second positions.

20. The craft of claim 19, further comprising a proximity sensor contained in the removable plate, the proximity sensor configured to sense when the portion of the catch receives the pin to verify a position of the pin.
